(19) United States
(12) Patent Application Publication
(10) Pub. No.: US 2020/0394688 A1
(43) Pub. Date: Dec. 17, 2020

(54) SOFTWARE WITH INTELLIGENT DASHBOARD FOR MANAGING NON-PROFITS AND METHOD OF USES THEREOF

(71) Applicant: Dot Solutions LLC, Lynchburg, VA (US)

(72) Inventors: Jon Matthew LOFLIN, Goode, VA (US); Brett MCDONOUGH, Jackson, WY (US); Salvatore FERLISE, Lynchburg, VA (US); Joshua WORRET, Lynchburg, VA (US)

(21) Appl. No.: 16/901,186

(22) Filed: Jun. 15, 2020

Related U.S. Application Data
(60) Provisional application No. 62/861,427, filed on Jun. 14, 2019.

(51) Int. Cl. G06Q 30/02; G06Q 40/00; G06F 3/0482; G06F 3/0483; G06F 3/0484; G06F 3/0486; G06F 9/451; G06F 9/54

(52) U.S. Cl. CPC G06Q 30/0279; G06Q 40/12; G06F 3/0482; G06F 9/542; G06F 3/04845; G06F 3/0486; G06F 9/453; G06F 3/0483

(57) ABSTRACT

Software with an intelligent dashboard for managing non-profits includes a top display layer and a bottom program layer. The top display layer has an intelligent dashboard configured for providing a first visual interactive display for an executive director of the non-profit. The top display layer is configured for allowing a quick view of specific data points from management application tools. The bottom program layer is the management application tools. The bottom program layer is configured to drive the executive director through the intelligent dashboard to connect the management application tools within the non-profit to drive greater efficiency and effectiveness of the non-profit.

### CROSS-REFERENCE TO RELATED APPLICATIONS

This application claims the priority benefit of U.S. Provisional Application No. 62/861,427, filed on Jun. 14, 2019, entitled “Software with Intelligent Dashboard for Managing Non-Profits”, which is incorporated by reference herein in its entirety.

### FIELD OF THE DISCLOSURE

The present disclosure relates to software or a technology platform that is designed to allow non-profit leaders to connect the dots (important management applications/tools) within their organization to drive greater efficiency and effectiveness. The software or technology platform utilizes a threefold approach to assisting non-profits in becoming more efficient and effective that consists of software applications, a training library, and a coaching or consulting network.

### BACKGROUND

Generally speaking, a nonprofit organization, also known as a non-business entity, not-for-profit organization, or nonprofit institution, is an organization traditionally dedicated to furthering a particular social cause or advocating for a shared point of view. In economic terms, it is an organization using its surplus of the revenues to further achieve its ultimate objective, rather than distributing its income to the organization's shareholders, leaders, or members. Being public extensions of a nation's revenue department, nonprofits are tax-exempt or charitable, meaning they do not pay income tax on the money that they receive for their organization. They can operate in religious, scientific, research, or educational settings.

Some of the key aspects of nonprofits are accountability, trustworthiness, honesty, and openness to every person who has invested time, money, and faith into the organization. Nonprofit organizations are accountable to the donors, founders, volunteers, program recipients, and the public community. Public confidence is a factor in the amount of money that a nonprofit organization is able to raise. The more nonprofits focus on their mission, the more public confidence they will have, and as a result, more money for the organization. The activities a nonprofit is partaking in can help build the public's confidence in nonprofits, as well as how ethical the standards and practices are.

An executive director [ED] is often the single point of accountability for driving the growth, efficiency, and day-to-day operations of a non-profit organization. They are responsible for accounting, board management, donor relations, varying levels of program & project management, events, human resources, and public relations & communication all while balancing other priorities such as their family, personal schedules, etc. As an example, faith based leaders of Christian non-profit organizations may be required to manage many critical areas which can become disjointed and overwhelming, where such faith based executive directors may lose their love for the vision. As such, there is clearly a need for a product, means, or method that empowers executive directors of non-profits so that they can effectively manage to inspire and change lives through their non-profit organization.

The instant disclosure may be designed to address at least certain aspects of the problems or needs discussed above by providing software with an intelligent dashboard for managing non-profits.

### SUMMARY

The present disclosure solves the aforementioned limitations of the currently available devices and methods, by providing software with an intelligent dashboard for managing non-profits. Accordingly, in one aspect, the present disclosure embraces software for managing a non-profit. The software for managing a non-profit may generally include a top display layer and a bottom program layer. The top display layer may have an intelligent dashboard. The intelligent dashboard is configured for providing a first visual interactive display for an executive director of the non-profit. Wherein the top display layer may be configured for allowing a quick view of specific data points from management application tools. The management application tools may include proprietary software and non-proprietary software. The bottom program layer may be the management application tools. The bottom program layer may be configured to drive the executive director through the intelligent dashboard to connect the dots of the management application tools within the non-profit to drive greater efficiency and effectiveness of the non-profit.

One feature of the disclosure may be that the software can be configured to enable the executive director of the non-profit to understand critical moving pieces of the non-profit, where the intelligent dashboard integrates the important management application tools with custom workflows configured to guide the executive director into leveraging industry leading and proven best practices for managing the non-profit.

Another feature of the disclosed software for managing non-profits may be that the intelligent dashboard can be configured to reduce requirements for the executive director to remember or manually navigate a plethora of systems required to run the non-profit on a daily basis, where the intelligent dashboard may be configured to surface key data points, metrics, steps, and action items from the important management application tools with the custom workflows into the top display layer that is configured to automatically highlight or notify the executive director when something requires attention.

Another feature of the disclosed software for managing non-profits may be that the intelligent dashboard may be configured to grow to include enriched training content with the custom workflows that guide the executive director on the specific area requiring attention. Whereby the executive director may be empowered to effectively deploy a vision and ultimately inspire and change lives in a increasingly simplified, organized and intentional way.

In select embodiments of the disclosed software for managing a non-profit, the intelligent dashboard may include an accounting gauge. The accounting gauge may be configured to highlight key financial items that aim to keep the non-profit on track from an accounting perspective. The accounting gauge may include accounting key performance indicators via integration with accounting software and via financial intermediary integration. The accounting key performance indicators may include, but are not limited to, current and last month balance, real time profit/loss, year to date, budget vs. actual data, and latest transaction where in select embodiments a user can hover for the last five latest transactions.

In select embodiments of the disclosed software for managing a non-profit, the intelligent dashboard may include a development gauge. The development gauge may be configured to pull information from across multiple modules to highlight organizational level metrics. The development gauge may include development key performance indicators from data within other modules including, but not limited to, last or most recent gifts, month to date donations, lapsed donor list, first time donors, and a prompt if donation is greater than a set donation amount.

In select embodiments of the disclosed software for managing a non-profit, the intelligent dashboard may include a donor pipeline module. The donor pipeline module may be configured to provide a structured approach to working with a donor in a step-by-step manner to cultivate a strong relationship with the donor and to intentionally align interest of the donor with an organizational project. The donor pipeline module may include a donor key performance indicator gauge and a donor overview. The donor key performance indicator gauge may include, but is not limited to, new contact where in select embodiments the user can hover for the last five new contacts, any red items, total money proposed, total money received, most recent closed where in select embodiments the user can hover for the last five most recent closed. In select embodiments, the donor pipeline module may include at least four unique categories including, but not limited to, individual, church, foundation, and organization. Each of the at least four unique categories may be configured to have a unique set of steps and action items that the steward should complete while navigating the timeline of the pipeline. In select embodiments, the donor pipeline module may include a list of donors where the user can click on each donor in the list to see a donor pipeline summary section where the user can click edit or continue to add detail including a contact tab, a proposal tab, a negotiation tab, a closure tab, and/or a steward tab. In select embodiments, the donor pipeline module may include a new donor pipeline section configured to add new donors to the donor pipeline module. In select embodiments, the donor pipeline module may include five vertical columns of phases, where each phase includes a plurality of steps to complete each phase, where the phases and steps are customizable, and a pipeline may be clicked and dragged from one phase to the next. In select embodiments, the donor pipeline module may include a filtering dropdown list of stewards, where the donor pipeline module will filter out every pipeline item that the selected steward is not the steward of, where pipeline widgets of active pipelines, proposed money, received money, and goal are updated. In select embodiments, the donor pipeline module may include a win and loss bucket section, where the user may drag a pipeline card into either a win bucket or a loss bucket configured to trigger a set of actions. Wherein, if won, a window appears asking for the amount received which will then filter into the pipeline widget for the received money. In other select embodiments, the donor pipeline module may include any of the various embodiments or combination of embodiments show and/or described herein.

In select embodiments of the disclosed software for managing a non-profit, the intelligent dashboard may include a project module configured for ideas, projects, events, grants, programs categorizes and project worksheets. The project module may have a project key performance indicators gauge and a project overview. In select embodiments, the project module may include rolling icons. In select embodiments, the project module may be configured to provide a structured approach to delivering various types of projects in a step-by-step manner. In select embodiments, the project module may be configured to emphasize proven steps and to send reminders to a project manager at key points in time. In select embodiments, the project module may include at least four unique types of projects including an ideas tab, a projects tab, an events tab, and a programs tab. Each type of project may have a unique set of steps and action items configured to be completed by the project manager while navigating the timeline of the pipeline. In select embodiments, the project module may include an overview page configured to summarize all of the ongoing projects with the ability to filter by category. In select embodiments, the project module may include a project workflow that consists of project details, steps to be taken, and ongoing status updates, where the ongoing status updates are configured to be submitted from a mobile device. When submitted the ongoing status updates may be configured to be sent to the executive director, whereby the executive director can then forward the ongoing status updates to others. In select embodiments, the project key performance indicators of the project module may include, but are not limited to: most recent created that may be configured to show the last five most recent created when hovered over; any item in projects that have turned red; most recent closed that may be configured to show the last five most recent closed when hovered over; latest field report that may be configured to show the last five latest field report when hovered over; number of individuals impacted year to date; and/or budget spend year to date. In select embodiments, the project module may include a project summary page configured to provide a single place where all of the project details will be shown and be updated including the overall summary, and a projects updates page with each project update. In other select embodiments, the project module may include any of the various embodiments or combination of embodiments show and/or described herein.

In select embodiments of the disclosed software for managing a non-profit, the intelligent dashboard may include a user management component. The user management component may be configured for users and donors. The user management component may be configured to add and manage users, to add donors, and to sync with customer relationship management software. The user management component may be configured to focus on two area, donor management and user management. In select embodiments, the user management component may be configured to be a place where an authorized user can add or edit donors. In select embodiments, the user management component may be configured to allow the authorized user to setup and sync with the customer relationship management software. In select embodiments, the user management component may include a list of donors page with links to view and edit each donor in an add/edit donor page with a submit new donor confirmation window. In select embodiments, the user management component may be configured to enable administrators to add users and edit their permissions. In select embodiments, the user management component may include a list of users page with links to view and edit each user in an add/edit user page with a submit new user confirmation window. In other select embodiments, the user management component may include any of the various embodiments or combination of embodiments show and/or described herein.

In select embodiments of the disclosed software for managing a non-profit, the intelligent dashboard may include an email widget component. The email widget component may be configured to integrate with email applications, like Microsoft® exchange or Gmail®. In select embodiments, the email widget component may be configured to give the executive director a view into the email applications without the need of going into the email applications. In select embodiments, the email widget component may be configured to keep the executive director focused on broader aspects of the non-profit organization and not working only out of an inbox of the email applications. In select embodiments, the email widget component may include email key performance indicators including, but not limited to, a number of unread email count and the five most recent emails with from and subject. In other select embodiments, the email widget component may include any of the various embodiments or combination of embodiments show and/or described herein.

In select embodiments of the disclosed software for managing a non-profit, the intelligent dashboard may include a feedback component. The feedback component may be configured to provide the ability to provide feedback to a product team. In select embodiments, the feedback component may be configured to have a basic ability that will enable users to provide feedback to the team. In select embodiments, ideas can be marked with a smiley face or a frowning face configured to capture sentiment. In select embodiments, the feedback component may be configured to include a brief message and a screenshot.

Another feature of the disclosure may be that the intelligent dashboard may be configured to leverage data insights from the accounting gauge, the development gauge, the donor pipeline module, the project module, the user management component, the email widget, and/or the feedback component for more use of the executive directors time as well as more efficiency to the organization.

In select embodiments of the disclosed software for managing a non-profit, the intelligent dashboard may further include a board engagement module or a human resources administration and management module.

Another feature of the disclosure may be that the intelligent dashboard may be configured as an initial entry point for the executive director where it contains roll-up key performance indicators from the management application tools, a place to drag and drop files the executive director references on a regular basis. Whereby the intelligent dashboard may be configured to allow the executive director to manage users, add donors, and see relevant notifications.

In select embodiments of the disclosed software for managing a non-profit, the intelligent dashboard may further include a reports module. The reports module may be configured to provide a streamlined process to transfer information and updates to stakeholders from the respective supported projects and programs. In select embodiments, the reports module may be configured to allow a user to create a report which has customizable fields to be filled out by the field personnel. In select embodiments, the reports module may be configured to provide reports on recurring or predetermined frequencies. In select embodiments, the reports module may be configured for field personnel to have access to the donor pipeline module under a special user type that will allow them to view, edit and submit their completed reports. In select embodiments, the reports module may be configured to provide a notification to the user with the applicable permissions for review after the report has been submitted by the field personnel. In select embodiments, the reports module may be configured to send out a report to all of the stakeholders that have been assigned to that report once the applicable user has reviewed and finalized the report. In select embodiments, the reports module may be configured add a report in two ways: manual addition via a new reports page; and association with a donation target where a user can select a donation target as stakeholder for a report, whereby the user is making all givers in that donation target stakeholders for the report. One feature of the reports module may be that it can be configured wherein, when a report is created, stakeholders are defined, and when a report is completed, the report is reviewed and the report is sent to stakeholders. In other select embodiments, the reports module may include any of the various embodiments or combination of embodiments show and/or described herein.

In another aspect, the instant disclosure embraces the software for managing a non-profit in any embodiment and/or combination of embodiments shown and/or described herein.

In another aspect, the instant disclosure embraces a method for managing a non-profit. The method for managing a non-profit may generally include utilizing the software for managing a non-profit in any of the embodiments and/or combination of embodiments shown and/or described herein. In general, the method for managing a non-profit may include the general steps of providing the disclosed software for managing a non-profit in any of the embodiments and/or combination of embodiments shown and/or described herein. With the provided software for managing a non-profit, the method for managing a non-profit may further include the step of the executive director utilizing the provided software to manage the non-profit.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a mockup flow chart of the intelligent dashboard of the software for managing non-profits according to select embodiments of the instant disclosure;

FIG. 2 is a mockup screenshot of the intelligent dashboard of the software for managing non-profits according to select embodiments of the instant disclosure;

FIG. 3 is a mockup screen shot of the donor pipeline module from the intelligent dashboard of the software for managing non-profits according to select embodiments of the instant disclosure;

FIG. 4 is a mockup screen shot of the new donor pipeline section of the donor pipeline module from the intelligent dashboard of the software for managing non-profits according to select embodiments of the instant disclosure;

FIG. 5 is a mockup screen shot of a donor pipeline summary section of the donor pipeline module from the intelligent dashboard of the software for managing non-profits according to select embodiments of the instant disclosure;

FIG. 6 is a mockup screen shot of a contact tab for the donor pipeline summary section of the donor pipeline module from the intelligent dashboard of the software for managing non-profits according to select embodiments of the instant disclosure;

FIG. 7 is another mockup screen shot of a contact tab for the donor pipeline summary section of the donor pipeline module from the intelligent dashboard of the software for managing non-profits according to select embodiments of the instant disclosure;

FIG. 8 is a mockup screen shot of a proposal tab for the donor pipeline summary section of the donor pipeline module from the intelligent dashboard of the software for managing non-profits according to select embodiments of the instant disclosure;

FIG. 9 is a mockup screen shot of a negotiation tab for the donor pipeline summary section of the donor pipeline module from the intelligent dashboard of the software for managing non-profits according to select embodiments of the instant disclosure;

FIG. 10 is a mockup screen shot of a closure tab for the donor pipeline summary section of the donor pipeline module from the intelligent dashboard of the software for managing non-profits according to select embodiments of the instant disclosure;

FIG. 11 is a mockup screen shot of a steward tab for the donor pipeline summary section of the donor pipeline module from the intelligent dashboard of the software for managing non-profits according to select embodiments of the instant disclosure;

FIG. 12 is another mockup screen shot of a proposal tab for the donor pipeline summary section of the donor pipeline module from the intelligent dashboard of the software for managing non-profits according to select embodiments of the instant disclosure;

FIG. 13 is another mockup screen shot of a negotiation tab for the donor pipeline summary section of the donor pipeline module from the intelligent dashboard of the software for managing non-profits according to select embodiments of the instant disclosure;

FIG. 14 is another mockup screen shot of a closure tab for the donor pipeline summary section of the donor pipeline module from the intelligent dashboard of the software for managing non-profits according to select embodiments of the instant disclosure;

FIG. 15 is a mockup screen shot of a donor key performance indicator gauge of the donor pipeline module from the intelligent dashboard of the software for managing non-profits according to select embodiments of the instant disclosure;

FIG. 16 is another mockup screen shot of a donor key performance indicator gauge of the donor pipeline module from the intelligent dashboard of the software for managing non-profits according to select embodiments of the instant disclosure;

FIG. 17 is a mockup screen shot of a project overview page of the project module from the intelligent dashboard of the software for managing non-profits according to select embodiments of the instant disclosure;

FIG. 18 is a mockup screen shot of an add or edit project page of the project module from the intelligent dashboard of the software for managing non-profits according to select embodiments of the instant disclosure;

FIG. 19A is a mockup screen shot of the top portion of an add project workflow page of the project module from the intelligent dashboard of the software for managing non-profits according to select embodiments of the instant disclosure;

FIG. 19B is a mockup screen shot of the middle portion of the add project workflow page of FIG. 19A;

FIG. 19C is a mockup screen shot of the bottom portion of the add project workflow page of FIG. 19A;

FIG. 20 is a mockup screen shot of a project summary page of the project module from the intelligent dashboard of the software for managing non-profits according to select embodiments of the instant disclosure;

FIG. 21 is a mockup screen shot of a projects update page of the project module from the intelligent dashboard of the software for managing non-profits according to select embodiments of the instant disclosure;

FIG. 22A is a mockup screen shot of a top portion of a mobile friendly project status update of the project module from the intelligent dashboard of the software for managing non-profits according to select embodiments of the instant disclosure;

FIG. 22B is a mockup screen shot of a bottom portion of the mobile friendly project status update of FIG. 22A;

FIG. 23 is a sample screen shot of a reports module for the intelligent dashboard of the software for managing non-profits according to select embodiments of the instant disclosure;

FIG. 24 is a sample screen shot of a new reports page of the reports module for the intelligent dashboard of the software for managing non-profits according to select embodiments of the instant disclosure;

FIG. 25 is a sample screen shot of another new reports page of the reports module for the intelligent dashboard of the software for managing non-profits according to select embodiments of the instant disclosure;

FIG. 26 is a mockup screen shot of a list of donors page of the user management component for the intelligent dashboard of the software for managing non-profits according to select embodiments of the instant disclosure;

FIG. 27A is a sample screenshot of the top portion of an add/edit donor page of the user management component for the intelligent dashboard of the software for managing non-profits according to select embodiments of the instant disclosure;

FIG. 27B is a sample screenshot of the bottom portion of the add/edit donor page of FIG. 27A;

FIG. 27C is a sample screenshot of the submit new donor confirmation window from the add/edit donor page of FIG. 27A;

FIG. 28 is a sample screenshot of a list of users page of the user management component for the intelligent dashboard of the software for managing non-profits according to select embodiments of the instant disclosure;

FIG. 29A is a sample screenshot of an add/edit user page of the user management component for the intelligent dashboard of the software for managing non-profits according to select embodiments of the instant disclosure;

FIG. 29B is a sample screenshot of the submit new user confirmation window from the add/edit user page of FIG. 29A; and

FIG. 30 is a flow chart of the method of managing a non-profit according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

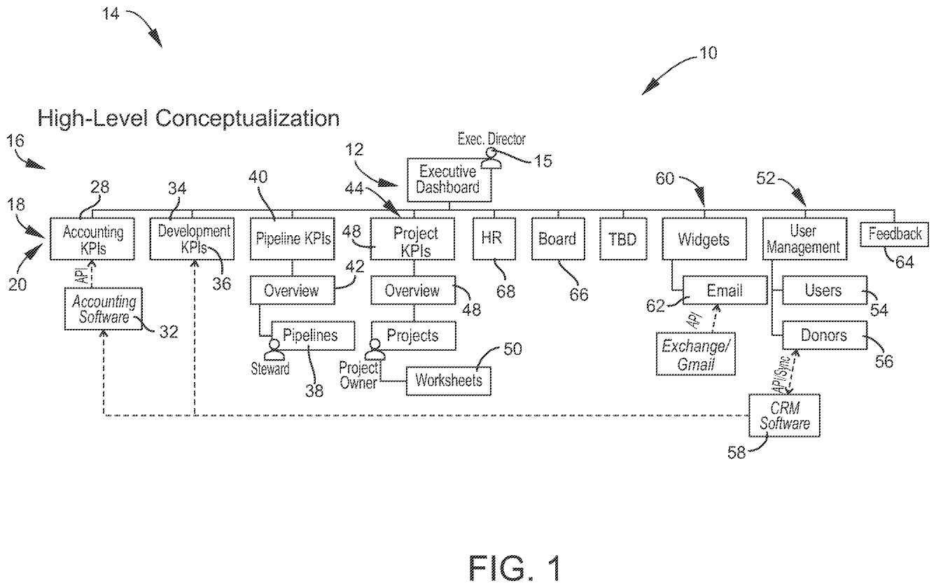

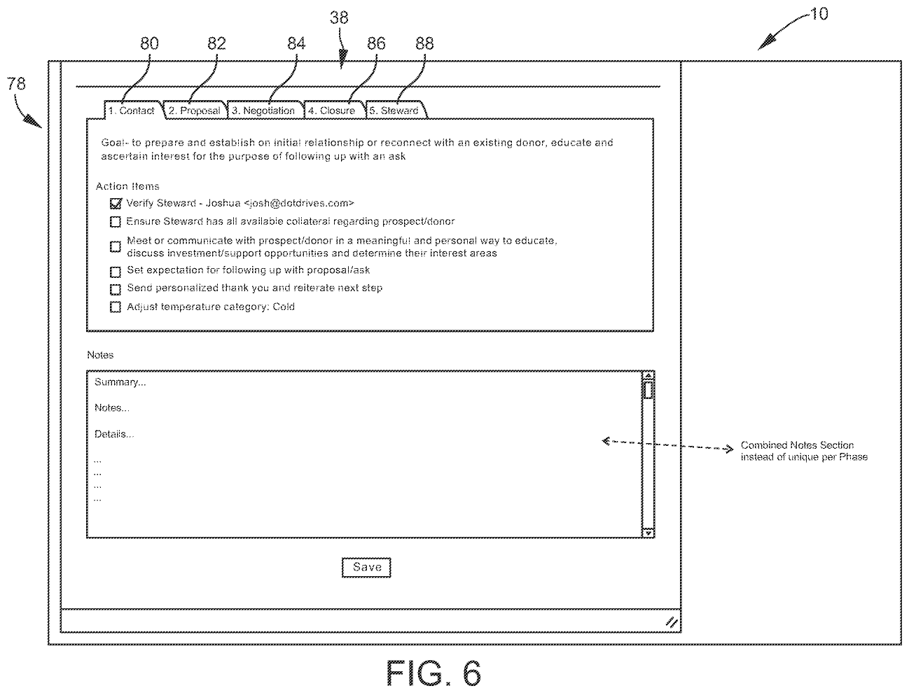

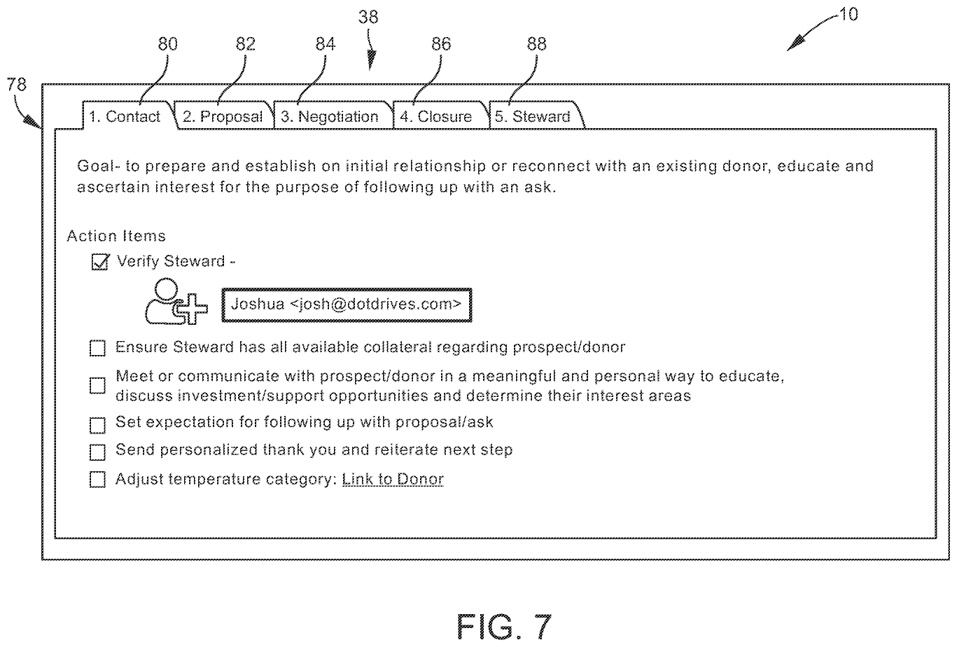

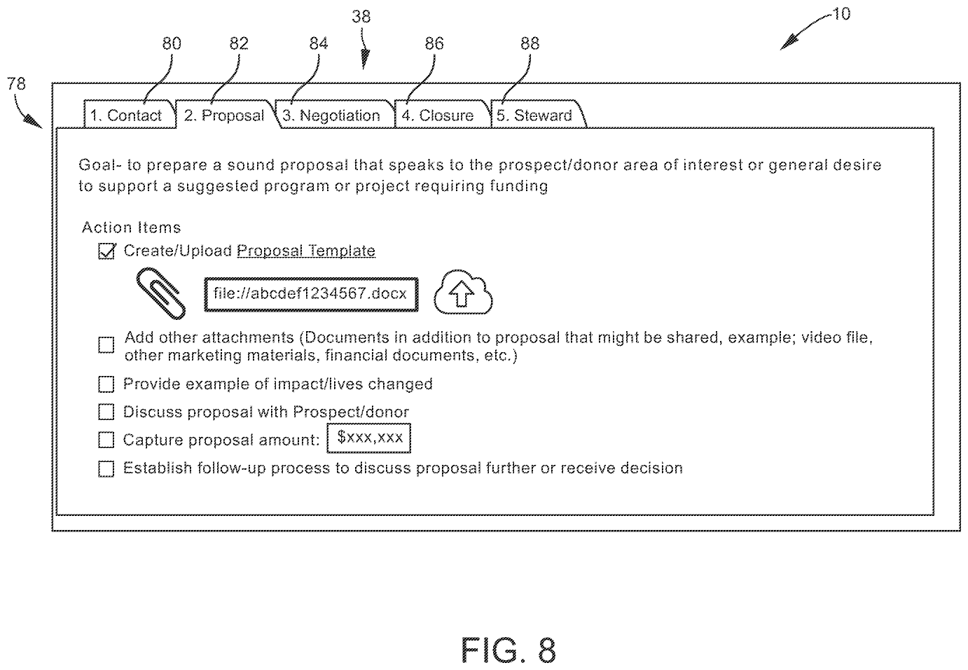

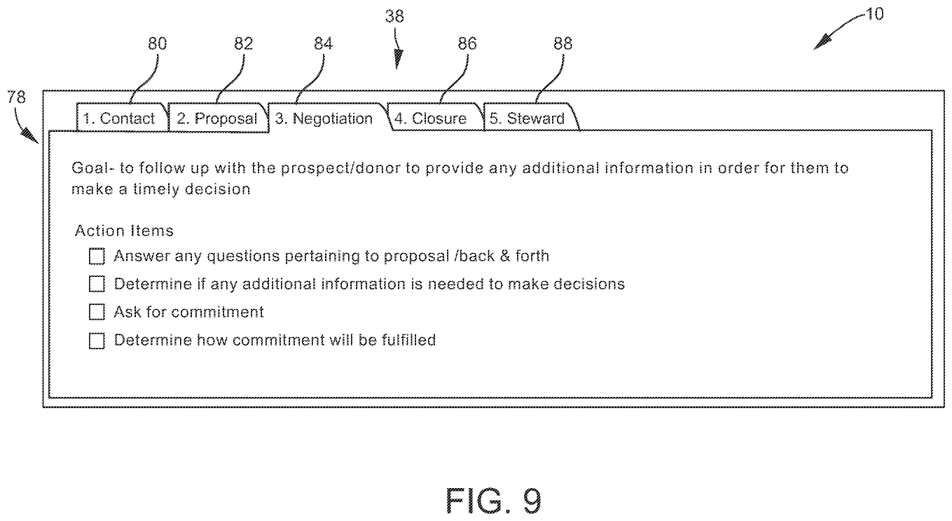

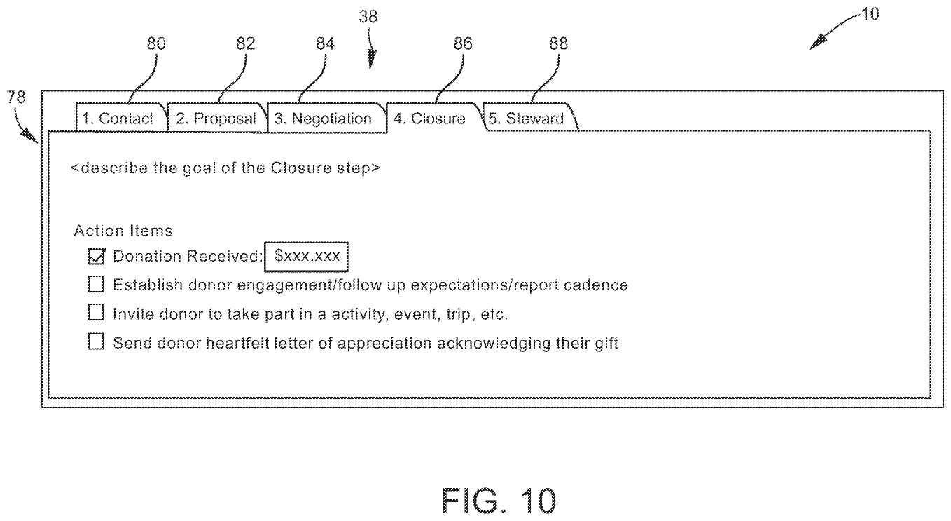

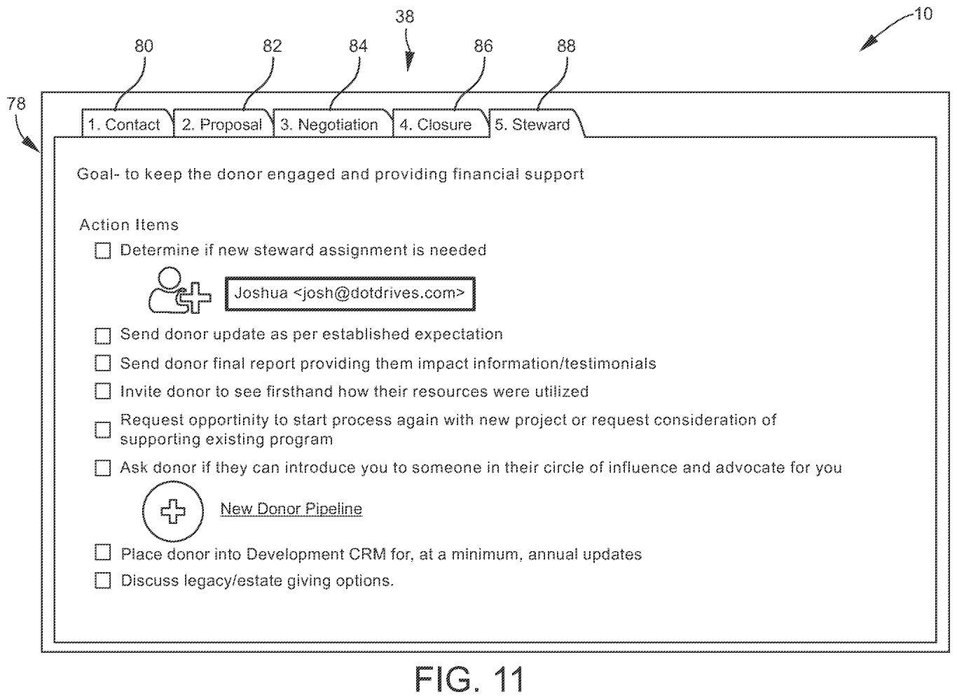

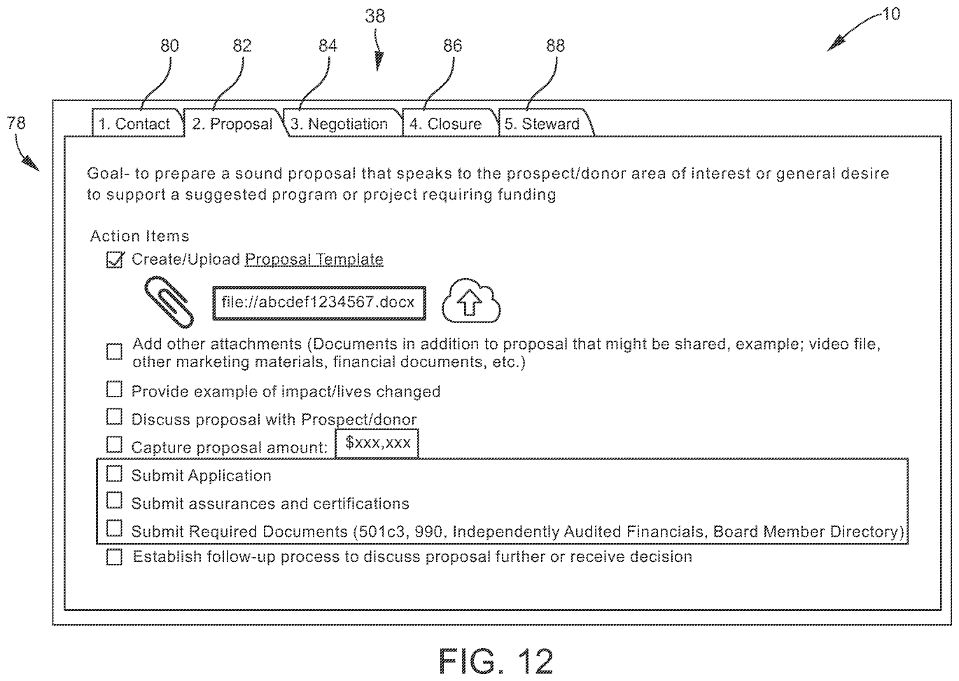

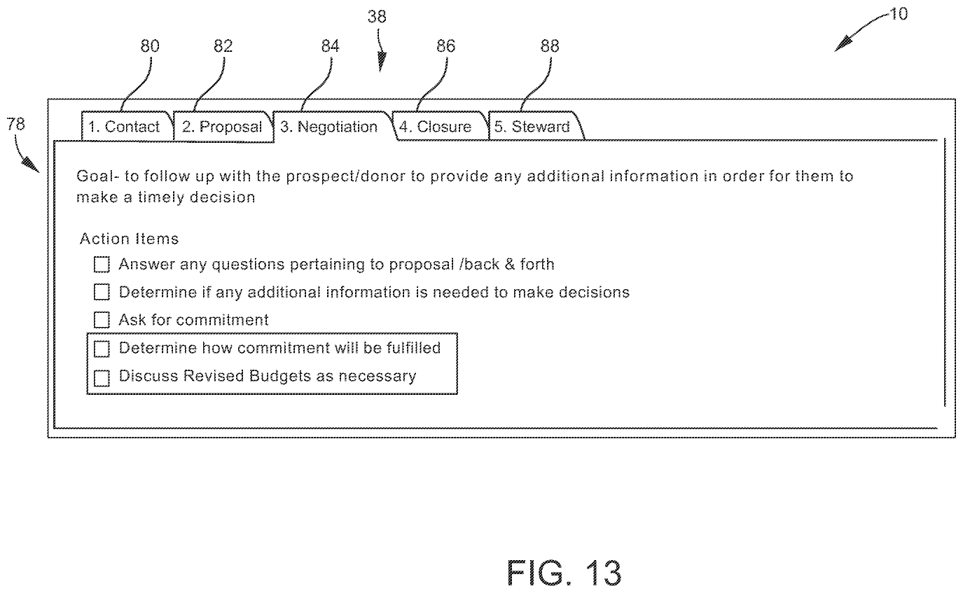

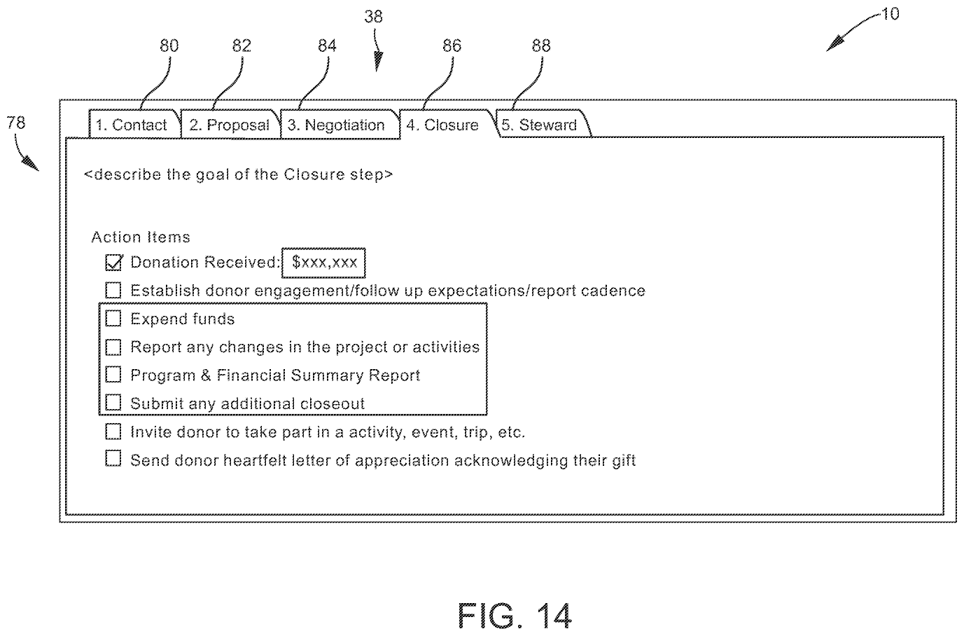

Referring now to FIGS. 1-30, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

The present disclosure solves the aforementioned limitations of the currently available resources for managing non-profits, by providing software 10 with intelligent dashboard 12 for managing non-profits 14. Software 10 for managing non-profit 14 may generally include top display layer 16 and bottom program layer 20. Top display layer 16 may have intelligent dashboard 12. Intelligent dashboard 12 may be configured for providing a first visual interactive display for executive director 15 of non-profit 14. Wherein, top display layer 16 may be configured for allowing a quick view of specific data points from management application tools 18. Management application tools 18 may include proprietary software and non-proprietary software. Bottom program layer 20 may be management application tools 18. Bottom program layer 20 may be configured to drive executive director 15 through intelligent dashboard 12 to connect the dots of management application tools 18 within non-profit 14 to drive greater efficiency and effectiveness of non-profit 14. Software 10 can be configured to enable executive director 15 of non-profit 14 to understand critical moving pieces of non-profit 14, where intelligent dashboard 12 integrates the important management application tools 18 with custom workflows 26 configured to guide executive director 15 into leveraging industry leading and proven best practices for managing non-profit 14. Intelligent dashboard 12 can be configured to reduce requirements for executive director 15 to remember or manually navigate a plethora of systems required to run non-profit 14 on a daily basis, where intelligent dashboard 12 may be configured to surface key data points, metrics, steps, and action items from the important management application tools 18 with custom workflows 26 into top display layer 16 that is configured to automatically highlight or notify executive director 15 when something requires attention. Intelligent dashboard 12 may also be configured to grow to include enriched training content with custom workflows 26 that guide executive director 15 on the specific area requiring attention. Whereby, executive director 15 may be empowered to effectively deploy a vision and ultimately inspire and change lives in an increasingly simplified, organized and intentional way.

Referring to FIG. 1, this figure highlights the multiple modules, users, and eventual integrations with other systems. Intelligent dashboard 12 then leverages data insights from these areas to enable increasingly more valuable use of executive directors 15 times as well as a more efficiency driven to the organization. As such, intelligent dashboard 12 may be the initial entry point for executive director 15. Intelligent dashboard 12 may contain roll-up key performance indicators, or KPIs, from the modules, a place to drag and drop a few files executive director 15 references on a regular basis. Intelligent dashboard 13 may also allow executive director 15 to easily manage users, add donors, and see relevant notifications.

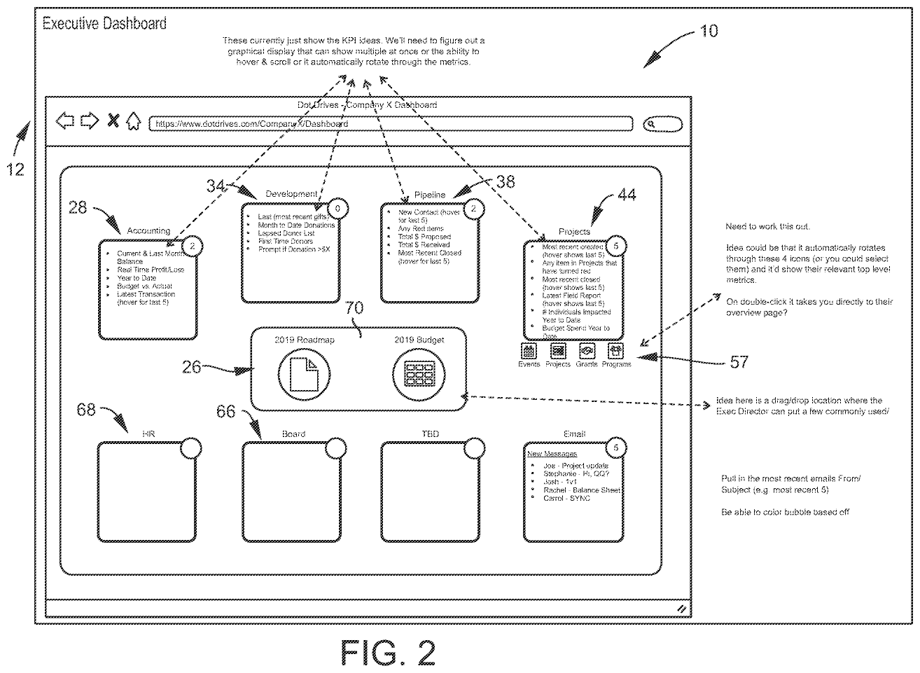

Accounting gauge 28 may be included in select embodiments of software 10 for managing non-profit 14. See FIGS. 1 and 2. Accounting gauge 28 may be included in intelligent dashboard 12. Accounting gauge 28 may be configured to highlight key financial items that aim to keep non-profit 14 on track from an accounting perspective. Accounting gauge 28 may include accounting key performance indicators 30 via integration with accounting software 32 (like Quickbooks® or other similar accounting software) and via financial intermediary integration. Accounting key performance indicators 30 may include, but are not limited to, current and last month balance, real time profit/loss, year to date, budget vs. actual data, and latest transaction where in select embodiments a user can hover for the last five latest transactions.

Development gauge 34 may be included in select embodiments of software 10 for managing non-profit 14. See FIGS. 1 and 2. Development gauge 34 may be included in intelligent dashboard 12. Development gauge 34 may be configured to pull information from across multiple modules to highlight organizational level metrics. Development gauge 34 may include development key performance indicators 36 from data within other modules including, but not limited to, last or most recent gifts, month to date donations, lapsed donor list, first time donors, and a prompt if donation is greater than a set donation amount.

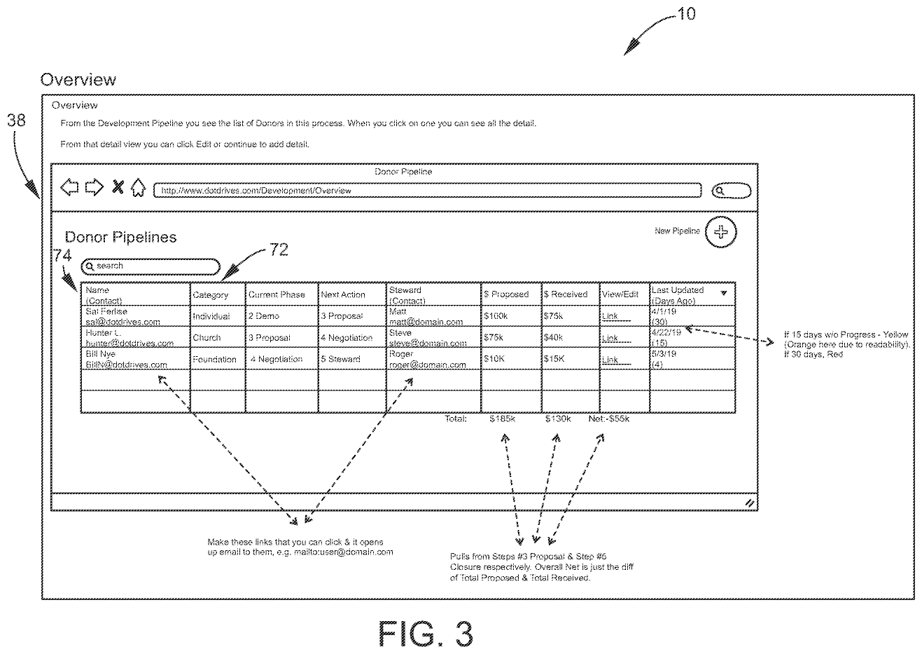

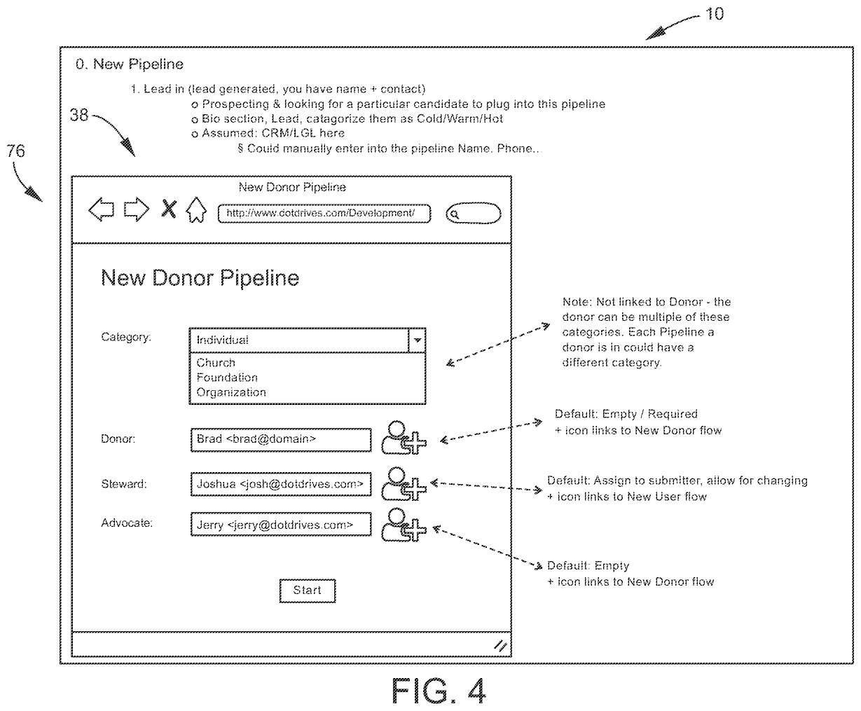

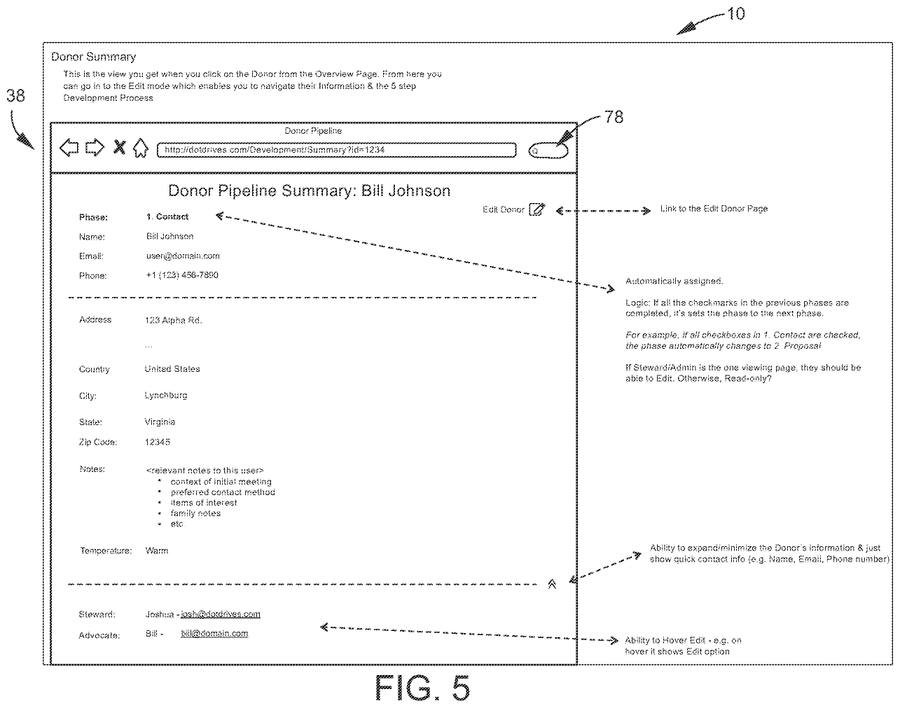

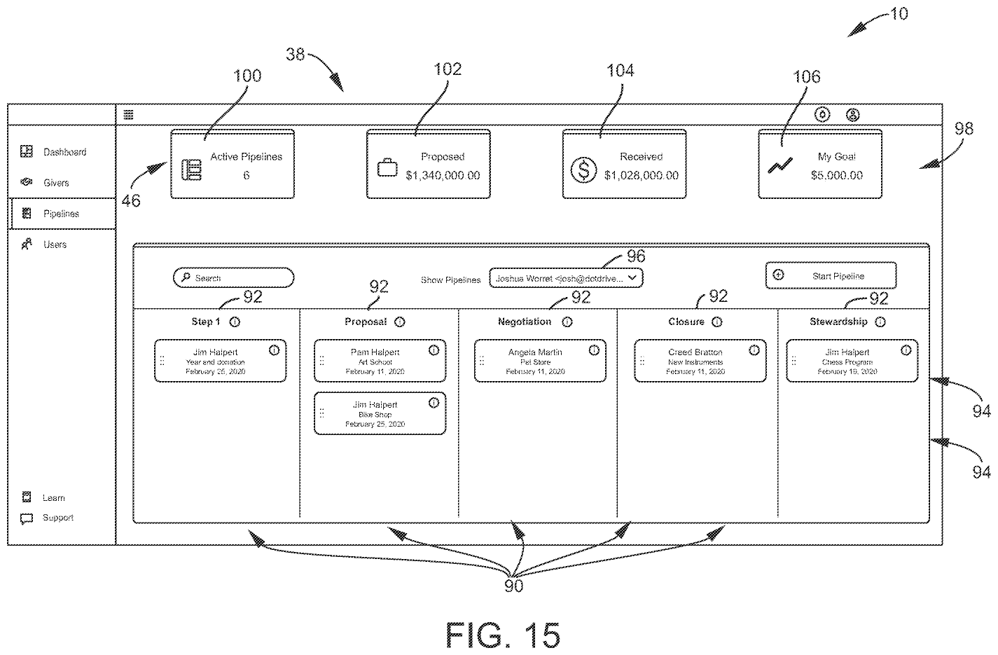

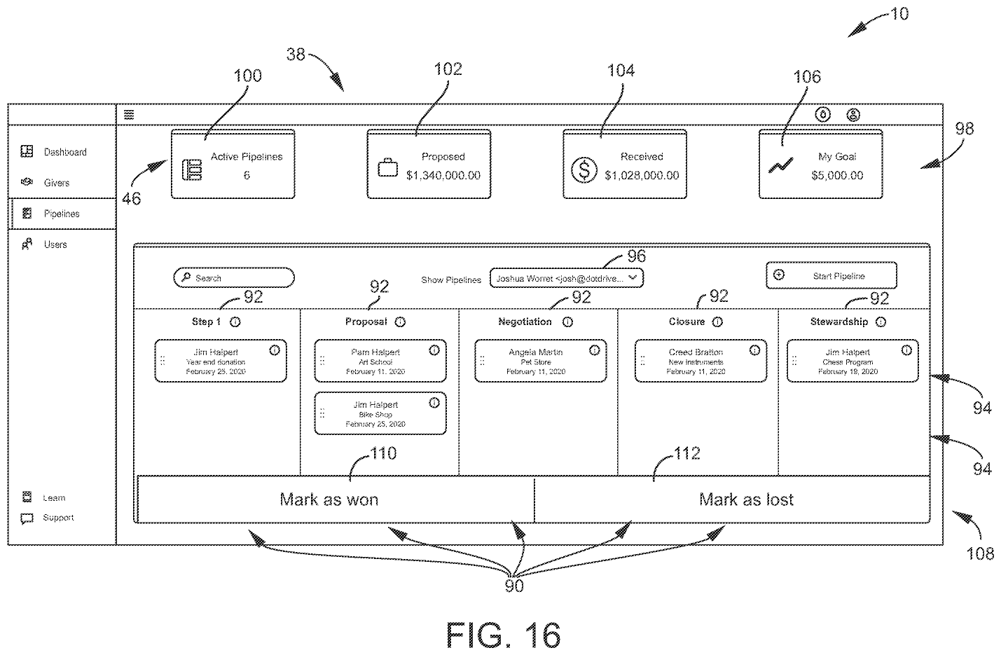

Donor pipeline module 38 may be included in select embodiments of software 10 for managing non-profit 14. See FIGS. 1 and 2. Donor pipeline module 38 may be included in intelligent dashboard 12. Donor pipeline module 38 may be configured to provide a structured approach to working with a donor in a step-by-step manner to cultivate a strong relationship with the donor and to intentionally align interest of the donor with an organizational project. Donor pipeline module 38 may include donor key performance indicator gauge 40 in intelligent dashboard 12, and donor overview 42. Donor key performance indicator gauge 40 may include, but is not limited to, new contact where in select embodiments the user can hover for the last five new contacts, any red items, total money proposed, total money received, most recent closed where in select embodiments the user can hover for the last five most recent closed. In select embodiments, donor pipeline module 38 may include at least four unique categories 72 including, but not limited to, individual, church, foundation, and organization, as shown in FIG. 3. Each of the at least four unique categories 72 may be configured to have a unique set of steps and action items that the steward should complete while navigating the timeline of the pipeline. In select embodiments, donor pipeline module 38 may include list of donors 74 where the user can click on each donor in the list to see a donor pipeline summary section 78 where the user can click edit or continue to add detail including contact tab 80, proposal tab 82, negotiation tab 84, closure tab 86, and/or steward tab 88. See FIGS. 5-14. In select embodiments, donor pipeline module 38 may include new donor pipeline section 76 configured to add new donors to donor pipeline module 38. See FIG. 4. Referring now to FIGS. 15-16, in select embodiments, donor pipeline module 38 may include five vertical columns 90 of phases 92, where each phase 92 can include a plurality of steps 94 to complete each phase 92. The phases 92 and steps 94 may be customizable, and a pipeline may be clicked and dragged from one phase 92 to the next. In select embodiments, donor pipeline module 38 may include filtering dropdown list 96 of stewards, where donor pipeline module 38 will filter out every pipeline item that the selected steward is not the steward of, where pipeline widgets 98 of active pipelines 100, proposed money 102, received money 104, and goal 106 are updated. Referring specifically to FIG. 16, in select embodiments, donor pipeline module 38 may include win and loss bucket section 108, where the user may drag a pipeline card into either win bucket 110 or loss bucket 112 configured to trigger a set of actions. Wherein, if won, a window appears asking for the amount received which will then filter into the pipeline widget 98 for the received money 104.

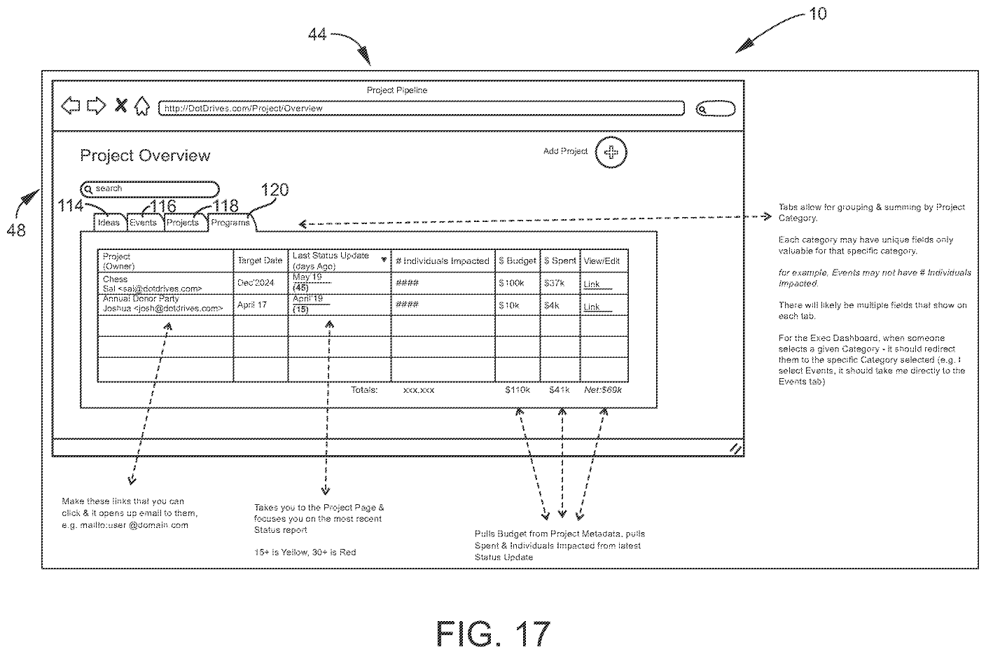

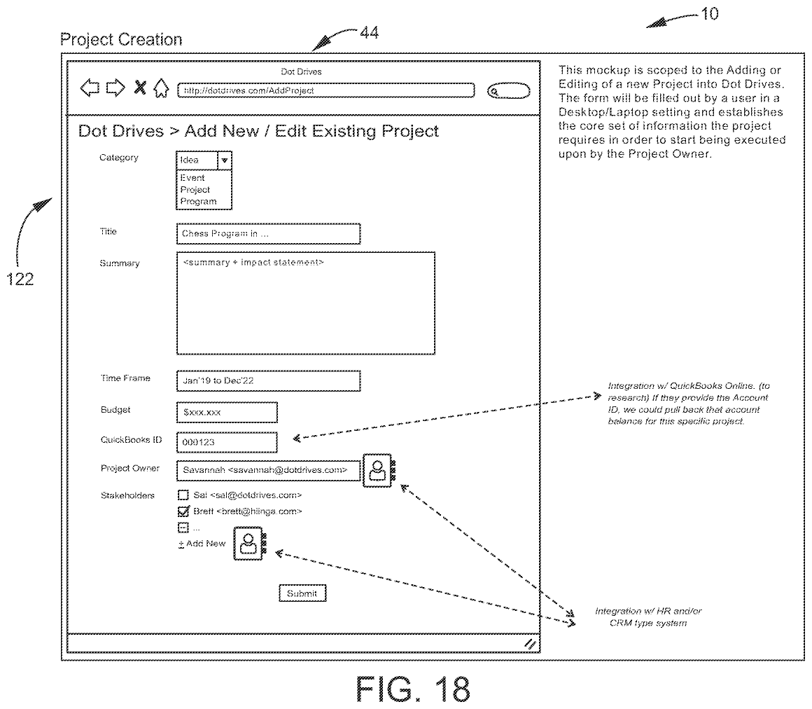

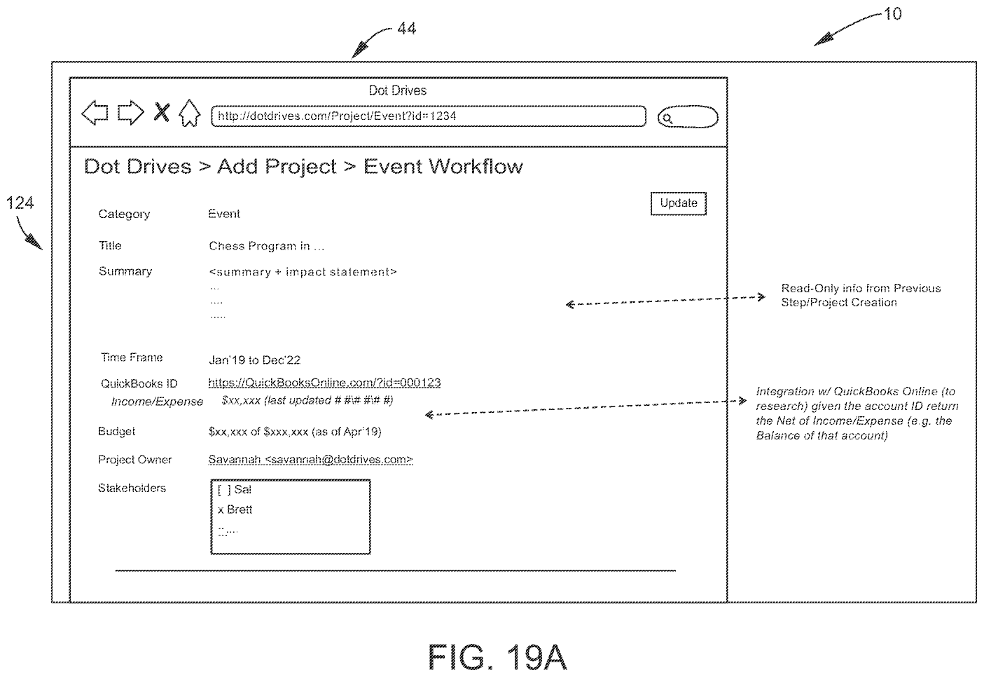

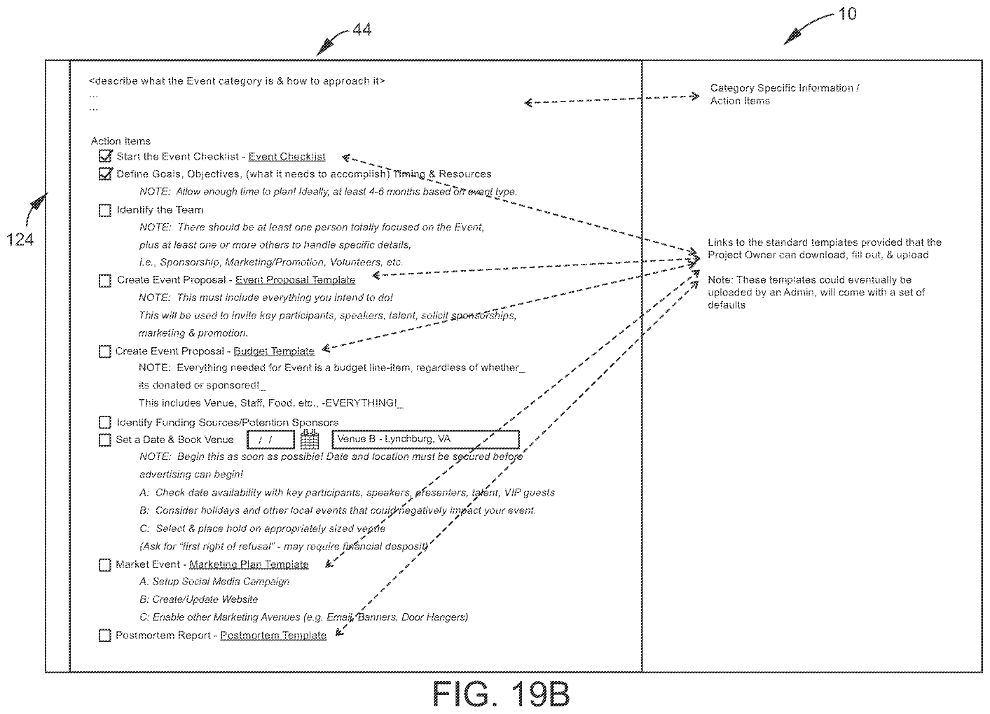

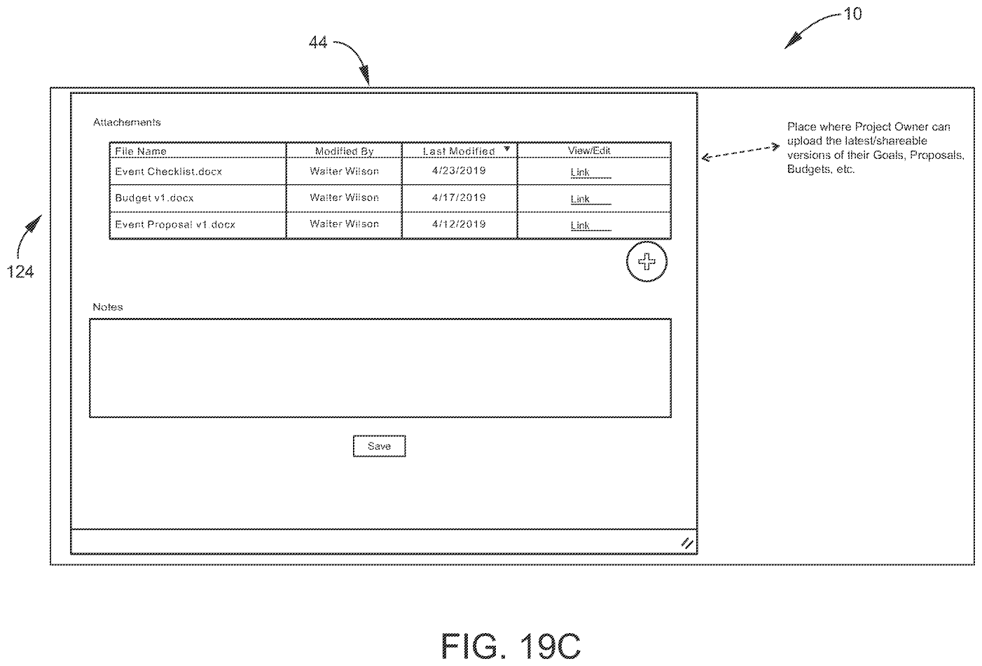

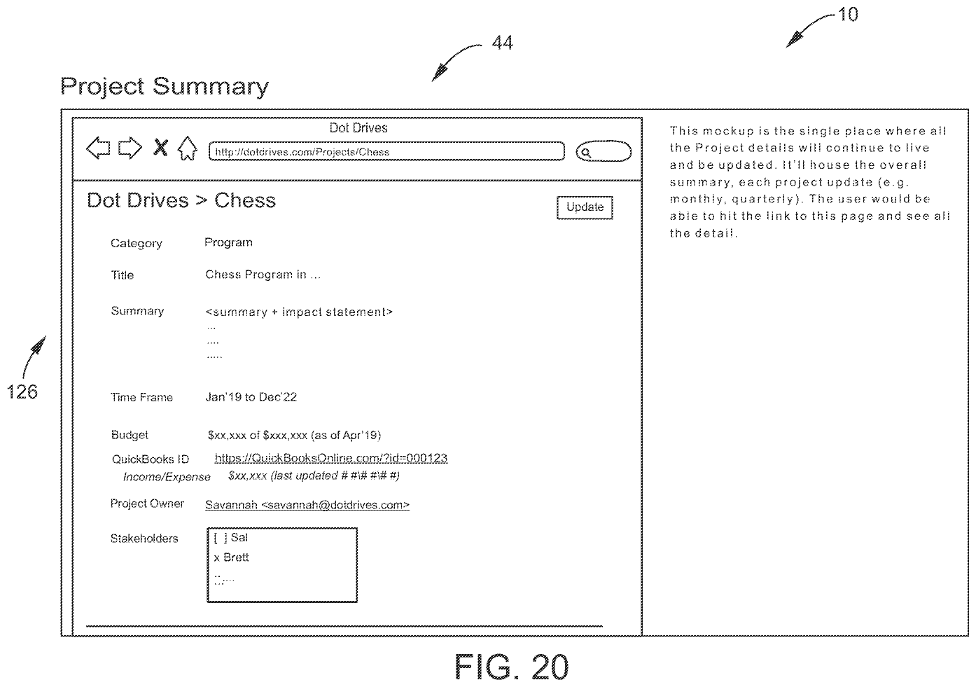

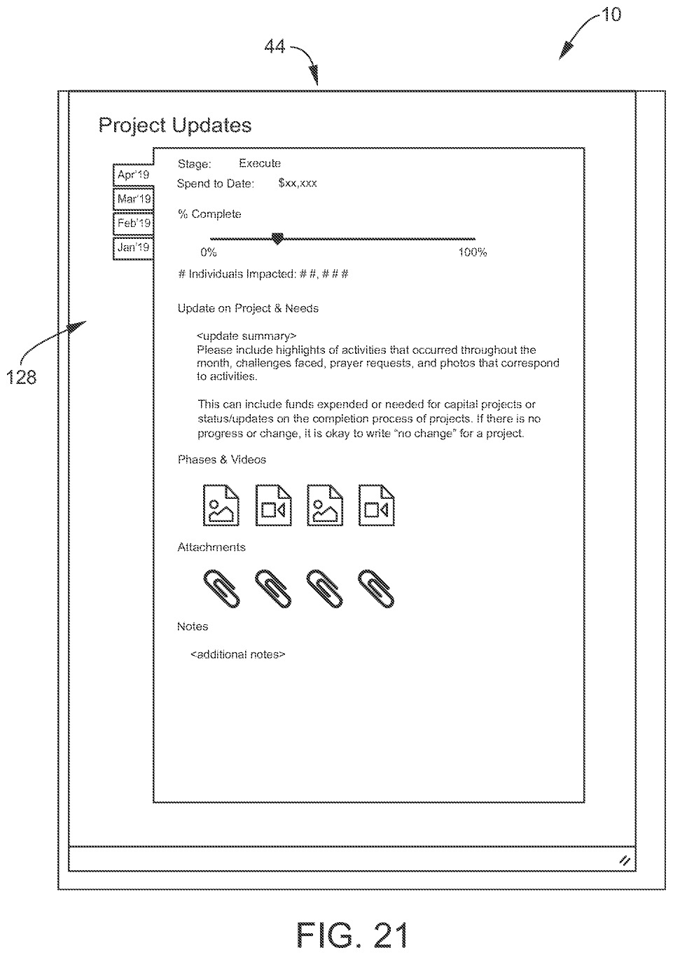

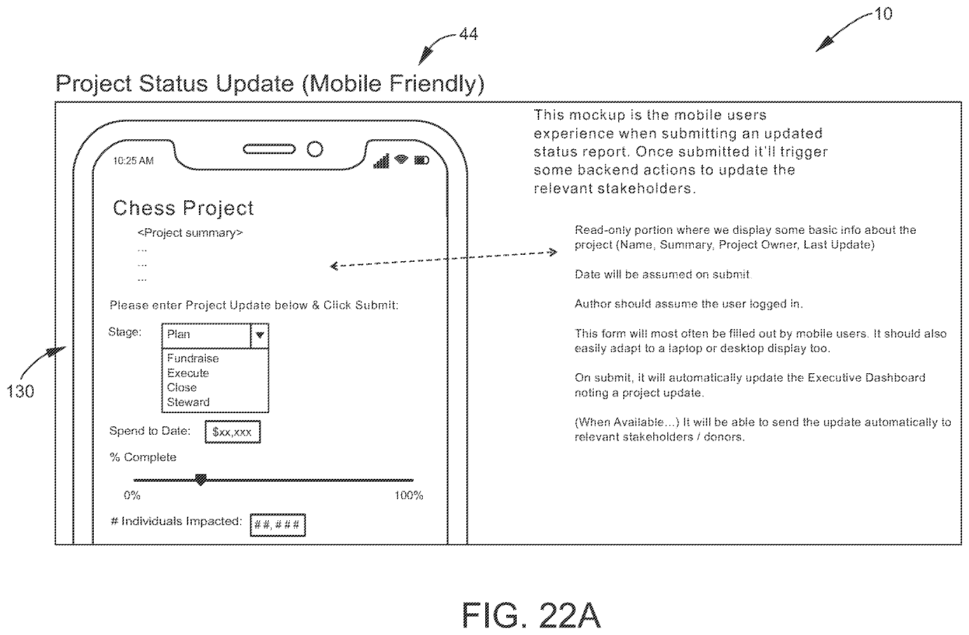

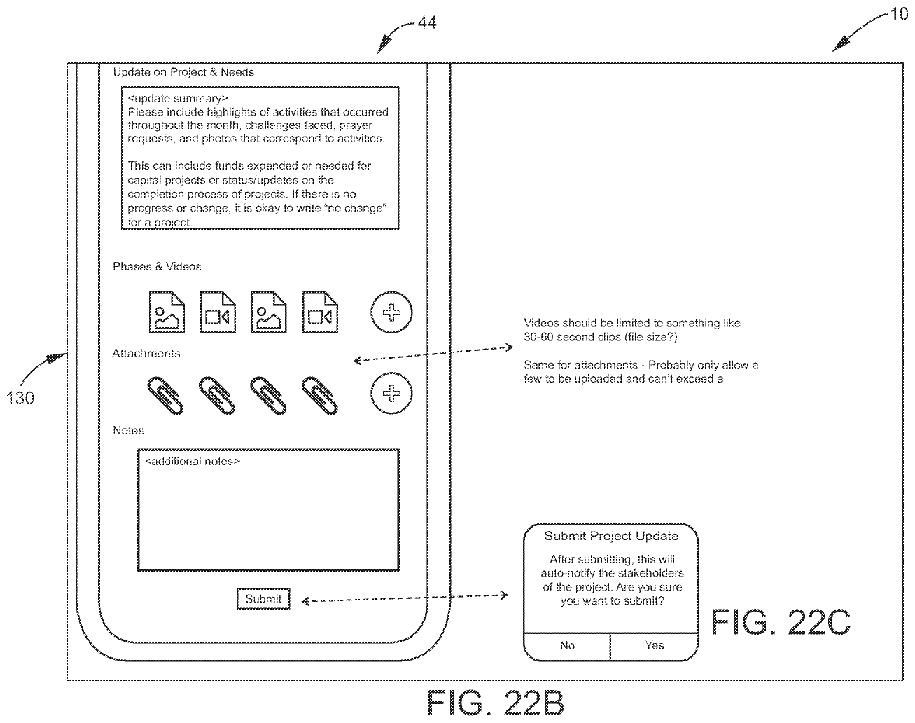

Project module 44 may be included in select embodiments of software 10 for managing non-profit 14. See FIGS. 1 and 2. Project module 44 may be included in intelligent dashboard 12. Project module 44 may be configured for ideas, projects, events, grants, programs categorizes and project worksheets 50. Project module 44 may have project key performance indicators gauge 46 and project overview 48. In select embodiments, project module 44 may include rolling icons 57 configured to automatically rotate through, or to be selected, to show their relevant top level metrics, where each icon could be double-clicked to take the user directly to their overview page. In select embodiments, project module 44 may be configured to provide a structured approach to delivering various types of projects in a step-by-step manner. In select embodiments, project module 44 may be configured to emphasize proven steps and to send reminders to a project manager at key points in time. In select embodiments, project module 44 may include at least four unique types of projects including, but not limited to, ideas tab 114, projects tab 118, events tab 116, and programs tab 120. See FIG. 17. Each type of project may have a unique set of steps and action items configured to be completed by the project manager while navigating the timeline of the pipeline. In select embodiments, project module 44 may include an overview page 48 configured to summarize all of the ongoing projects with the ability to filter by category. See FIG. 17. In select embodiments, project module 44 may include project workflow or worksheets 50 that consists of project details, steps to be taken and ongoing status updates, where the ongoing status updates may be configured to be submitted from a mobile device. When submitted the ongoing status updates may be configured to be sent to executive director 15, whereby executive director 15 can then forward the ongoing status updates to others. In select embodiments, project key performance indicators 46 of project module 44 may include, but are not limited to: most recent created that may be configured to show the last five most recent created when hovered over; any item in projects that have turned red; most recent closed that may be configured to show the last five most recent closed when hovered over; latest field report that may be configured to show the last five latest field report when hovered over; number of individuals impacted year to date; and/or budget spend year to date. As shown in FIG. 18, in select embodiments project module 44 may include add/edit project page 122. As shown in FIG. 19, in select embodiments project module 44 may include add project workflow page 124. In select embodiments, project module 44 may include a project summary page 126 configured to provide a single place where all of the project details will be shown and be updated including the overall summary, and a projects updates page with each project update. See FIG. 20. As shown in FIG. 21, in select embodiments project module 44 may include project updates page 128. As shown in FIGS. 22A-22B, in select embodiments, project module 44 may include mobile friendly project status update 130.

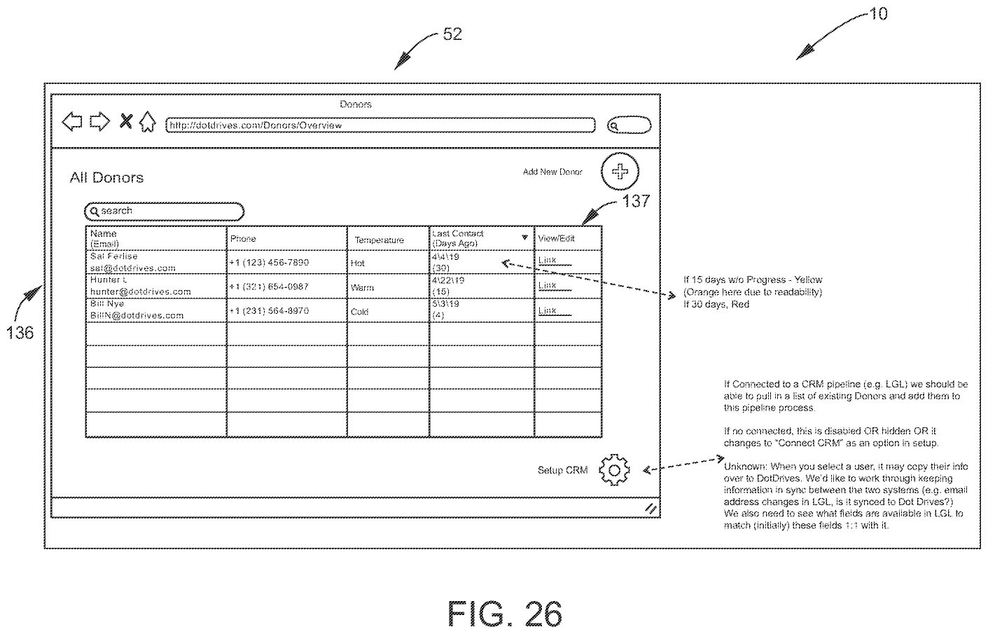

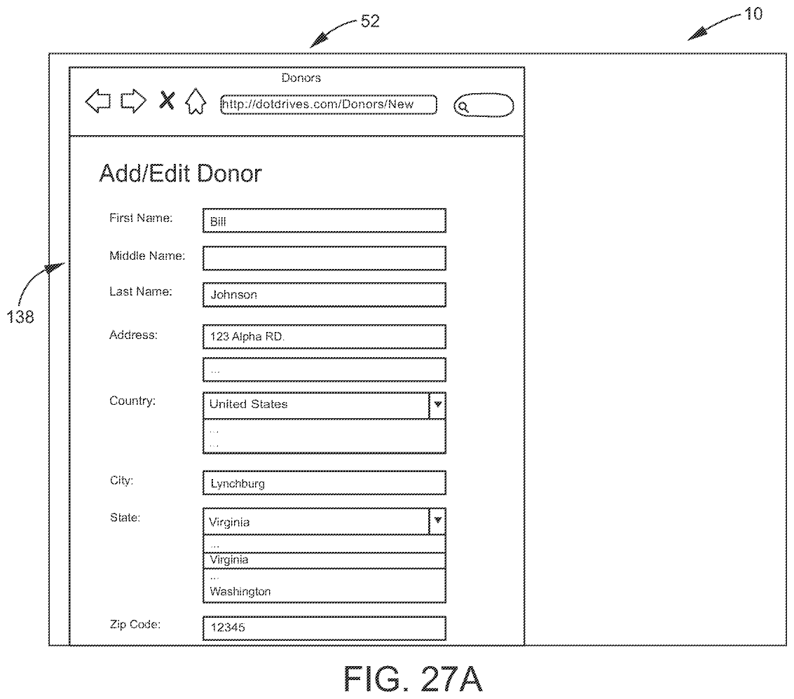

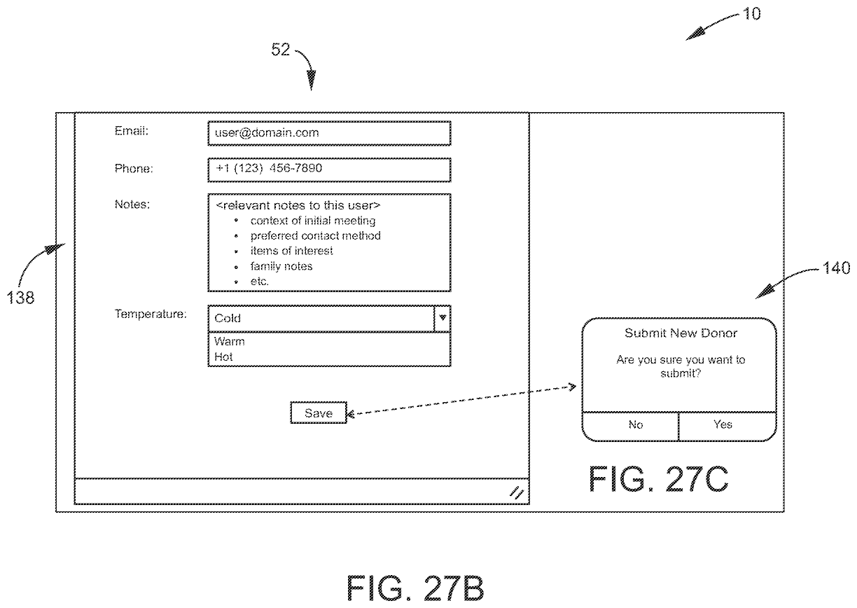

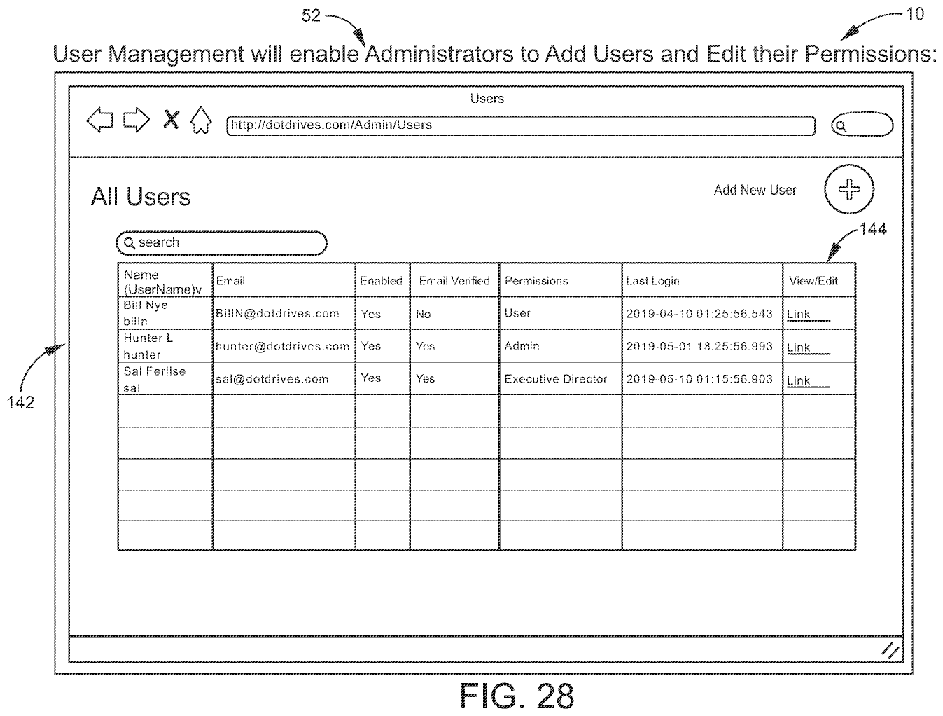

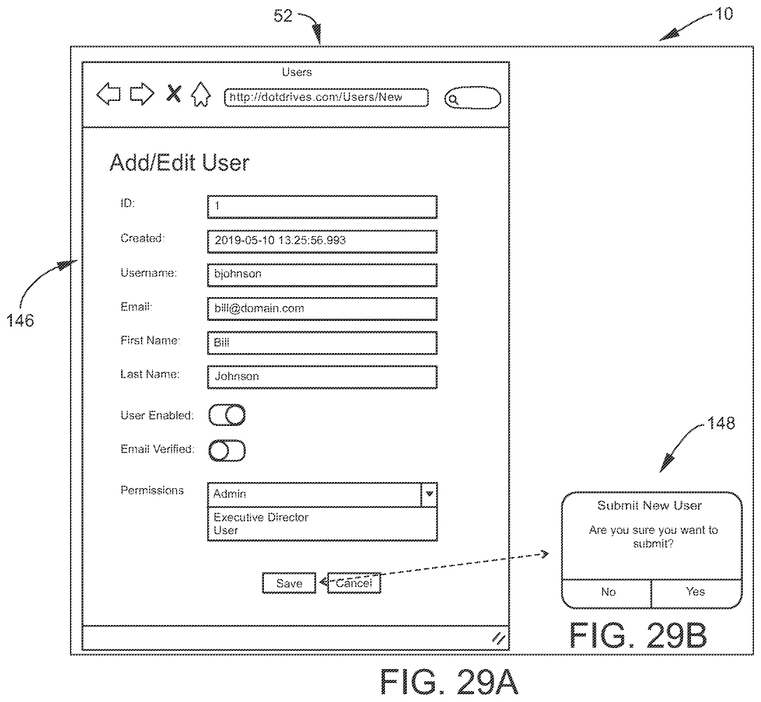

User management component 52 may be included in select embodiments of software 10 for managing non-profit 14. See FIGS. 1 and 2. User management component 52 may be included in intelligent dashboard 12. User management component 52 may be configured for users 54 and donors 56. User management component 52 may be configured to add and manage users 54, to add donors 56, and to sync with customer relationship management software 58, like Little Green Lights®. User management component 52 may be configured to focus on two areas: donor management and user management. In select embodiments, user management component 52 may be configured to be a place where an authorized user can add or edit donors. In select embodiments, user management component 52 may be configured to allow the authorized user to setup and sync with the customer relationship management software 58. In select embodiments, user management component 52 may include list of donors page 136 with links 137 to view and edit each donor in an add/edit donor page 138 with submit new donor confirmation window 140. See FIGS. 26, 27A, 27B and 27C. In select embodiments, user management component 52 may be configured to enable administrators to add users and edit their permissions. In select embodiments, user management component 52 may include list of users page 142 with links 144 to view and edit each user in an add/edit user page 146 with submit new user confirmation window 148. See FIGS. 28, 29A and 29B.

Email widget component 60 may be included in select embodiments of software 10 for managing non-profit 14. See FIGS. 1 and 2. Email widget component 60 may be configured to integrate with email applications 62, like Microsoft® exchange, Gmail®, or the like. In select embodiments, email widget component 60 may be configured to give executive director 15 a view into email applications 62 without the need of going into email applications 62. In select embodiments, email widget component 60 may be configured to keep executive director 15 focused on broader aspects of non-profit organization 14 and not working only out of an inbox of email applications 62. In select embodiments, email widget component 60 may include email key performance indicators including, but not limited to, a number of unread email count and the five most recent emails with from and subject.

Feedback component 64 may be included in select embodiments of software 10 for managing non-profit 14. See FIGS. 1 and 2. Feedback component 64 may be configured to provide the ability to provide feedback to a product team. In select embodiments, feedback component 64 may be configured to have a basic ability that will enable users to provide feedback to the team. In select embodiments, ideas can be marked with a smiley face or a frowning face configured to capture sentiment. In select embodiments, feedback component 64 may be configured to include a brief message and a screenshot.

Another feature of the disclosure may be that intelligent dashboard 12 may be configured to leverage data insights from accounting gauge 28, development gauge 34, donor pipeline module 38, project module 44, user management component 52, email widget component 60, and/or feedback component 64 for more use of executive directors 15 time as well as more efficiency to the organization.

In select embodiments of the disclosed software 10 for managing non-profit 14, intelligent dashboard 12 may further include board engagement module 66 and/or human resources administration and management module 68. See FIGS. 1 and 2.

Another feature of the disclosure may be that intelligent dashboard 12 may be configured as an initial entry point for executive director 15 where it contains roll-up key performance indicators from the management application tools 18, and place 70 to drag and drop files executive director 15 references on a regular basis. See FIG. 1. Whereby, intelligent dashboard 12 may be configured to allow executive director 15 to manage users, add donors, and see relevant notifications.

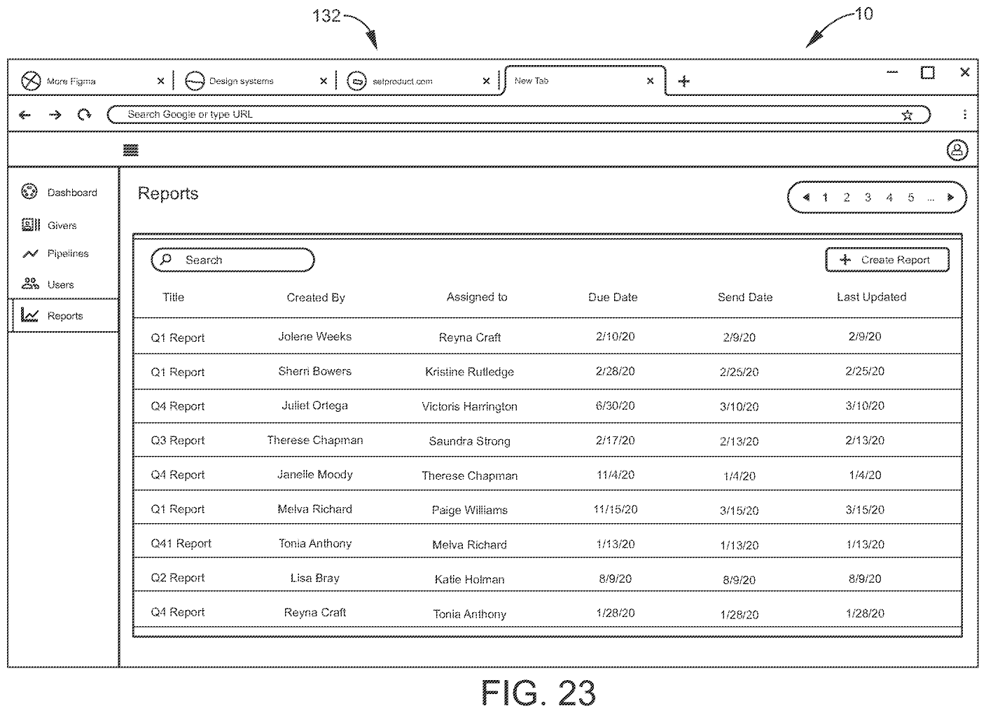

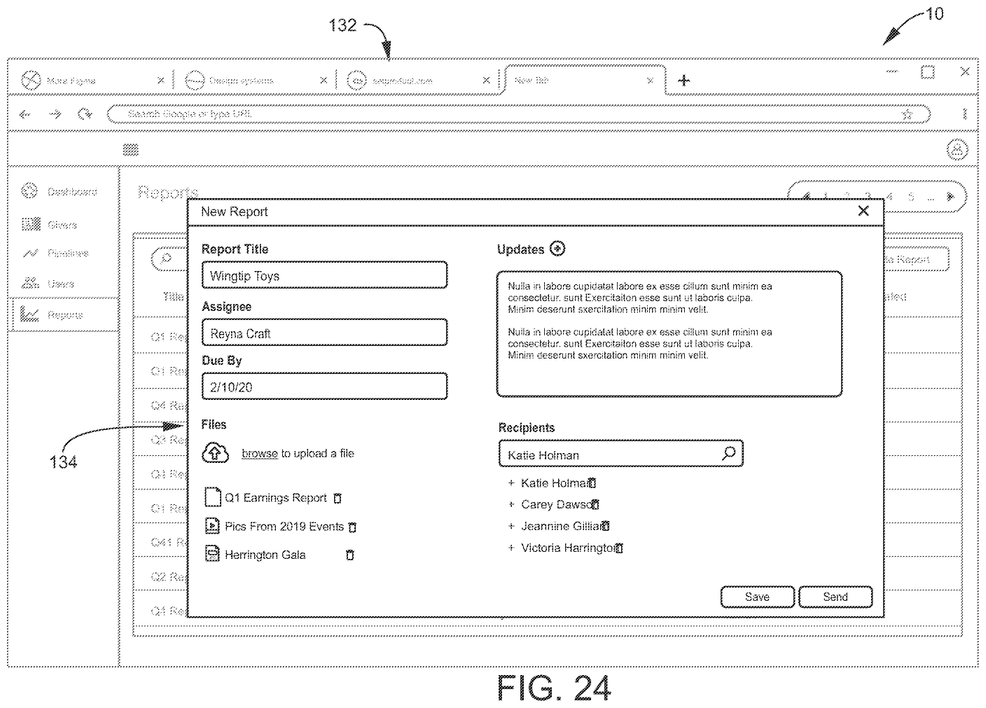

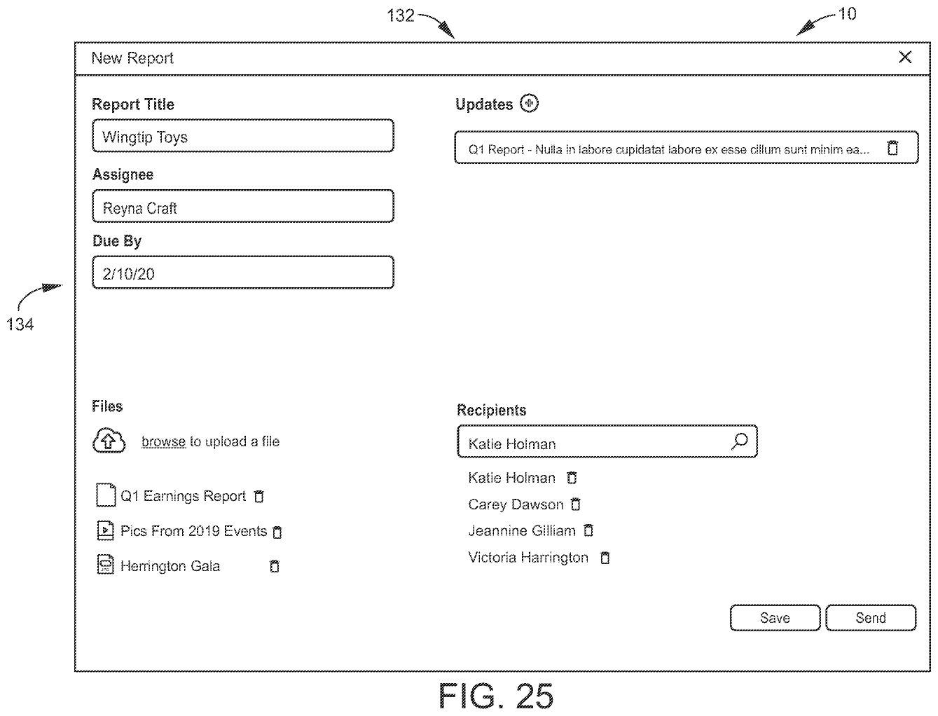

Reports module 132 may be included in select embodiments of software 10 for managing non-profit 14. See FIGS. 23-25. Reports module 132 may be included in intelligent dashboard 12 of software 10. Reports module 132 may be configured to provide a streamlined process to transfer information and updates to stakeholders from the respective supported projects and programs. In select embodiments, reports module 132 may be configured to allow a user to create a report which has customizable fields to be filled out by the field personnel. In select embodiments, reports module 132 may be configured to provide reports on recurring or predetermined frequencies. In select embodiments, reports module 132 may be configured for field personnel to have access to donor pipeline module 38 under a special user type that will allow them to view, edit and submit their completed reports. In select embodiments, reports module 132 may be configured to provide a notification to the user with the applicable permissions for review after the report has been submitted by the field personnel. In select embodiments, reports module 132 may be configured to send out a report to all of the stakeholders that have been assigned to that report once the applicable user has reviewed and finalized the report. In select embodiments, reports module 132 may be configured to add a report in two ways: manual addition via a new reports page 134 (see FIGS. 24-25); and association with a donation target where a user can select a donation target as stakeholder for a report, whereby the user is making all givers in that donation target stakeholders for the report. One feature of reports module 132 may be that it can be configured wherein, when a report is created, stakeholders are defined, and when a report is completed, the report is reviewed and the report is sent to stakeholders.

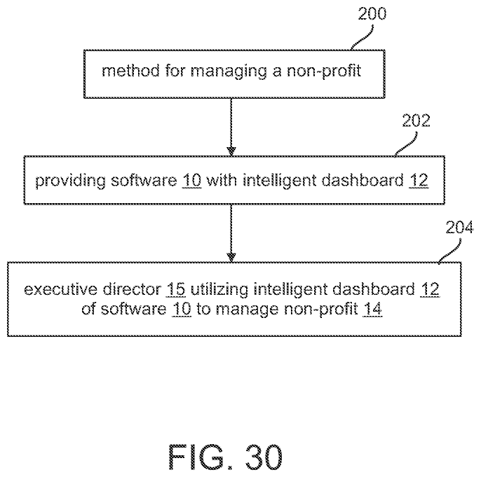

Referring now specifically to FIG. 30, in another aspect, the instant disclosure embraces method 200 for managing non-profit 14. Method 200 for managing non-profit 14 may generally include utilizing software 10 for managing non-profit 14 in any of the embodiments and/or combination of embodiments shown and/or described herein. In general, method 200 for managing non-profit 14 may include general step 202 of providing software 10 for managing non-profit 14 in any of the embodiments and/or combination of embodiments shown and/or described herein. With the provided software 10 for managing non-profit 14, method 200 for managing non-profit 14 may further include step 204 of executive director 15 utilizing the provided software 10 to manage non-profit 14.

In sum, the instant disclosure recognizes the need for a software application or technology platform that consists of a dashboard which will serve as the main computer based operating platform for executive leadership within non-profit organizations. Wherein, this intelligent dashboard 12 will be the first visual interactive display that the user will engage with on a daily basis. It will serve as the top layer allowing for a quick view of specific datapoints extracted from management application tools 18, which may include proprietary software applications and non-proprietary software applications. For example, proprietary applications will include but not be limited to: board engagement, project management, program management, development pipeline, administration management, idea incubator. Non-proprietary applications may include accounting software, HR management software and email applications such as Gmail® or Microsoft Outlook®.

Intelligent dashboard 12 may be designed as playful in terms of appearance (but not tacky), for example intelligent dashboard 12 could be an actual automobile dashboard with gauges and displays. These gauges and displays will serve as the datapoint displays for all the software management applications 18 that are linked to intelligent dashboard 12. For example, the accounting software will be displayed as a Fuel Gauge, and display specific data points such as, summary number for account Balances, I&E, and budget vs. actual. From the gauge location on intelligent dashboard 12, the user can drill down, access, the application the gauge is linked with, if they choose. Intelligent dashboard 12 can be designed and configured to operate in real-time. Intelligent dashboard 12 can also be designed and configured to provide certain indicators, in the form of color coding, when certain situations exist.

What may also be unique about software 10 may be that it can be designed to guide management behavior, through requiring the user to move between applications along with highlighting and triggering certain areas requiring attention. Software 10 may also consist of an inspection requirement which will automatically occur at specified times. This will be a process by which the leader is prompted to evaluate, reflect on and possibly update key documents that govern the organization. For example, but not limited to; annual strategic plan, vision and or mission statement, organization “DNA” or cultural practices, organization performance survey, ministry overview document, the like, etc.

Accordingly, software 10 may designed and configured to provide a technology platform that allows non-profit leaders to connect the dots (important management applications/tools) within their organization to drive greater efficiency and effectiveness. These applications will be designed so that it can encourage healthy management habits. By creating awareness and simple access to important management elements of the organization, individuals may be empowered to make more informed decisions. Whereby, leaders may be focused on important organizational management elements on a day to day basis and not fall prey to the urgent and often less significant matters that distract leaders from running an organization professionally.

At a very high-level, software 10 may be designed and created to enable executive director 15 to more easily understand the critical moving pieces of their businesses (non-profit 14). Software 10 may accomplish this by creating intelligent dashboard 12 that integrates with multiple sub-systems & custom workflows that can simply guide their end-users into leveraging industry leading, proven best practices for effectively managing Christian non-profits 14. This intellectual & simple intelligent dashboard 12 may aim to reduce (potentially eventually removing) the requirement for executive director 15 to remember and/or manually navigate the plethora of systems required to run a successful non-profit on a daily basis. Software 10 with intelligent dashboard 12 may accomplish this by surfacing the key data points, metrics, steps, and action items from modules & workflows into a single dashboard. Intelligent dashboard 12 may be designed and configured to automatically highlight and/or notify the user when something requires their attention and it'll grow to include enriched training content & workflows that guide the end-user on the specific area requiring attention. The net result is that executive director 15 and their team may be empowered to effectively deploy their visions and ultimately inspire and change lives in an increasingly simplified, organized, and intentional way.

The terminology used herein is for the purpose of describing particular embodiments only and is not intended to limiting of the disclosure. As used herein, the term “and/or” includes any and all combinations of one or more of the associated listed items. As used herein, the singular forms “a”, “an” and “the” are intended to include the plural forms as well as the singular forms, unless the contest clearly indicates otherwise. It will be further understood that the terms “compromises” and/or “comprising” when used in this specification, specify the presence of stated features, steps, operations, elements and/or components, but do not preclude the presence of addition of one or more other features, steps, operations, elements, components and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of thermal enhancements are disclosed. Each of these has individual benefit, and each can also be used in conjunction with one or more, or in some cases all, of the other disclosed techniques. Accordingly, for the sake of clarity, the description will refrain from repeating every possible combination of the individual steps in an unnecessary fashion. Nevertheless, the specification and claims should be read with the understanding that such combinations are entirely within the scope of the intervention and the claims.

It will be evident, however, to one skilled in the art that the present disclosure may be practiced without specific details.

The present disclosure is to be considered as an exemplification of the disclosure, and is not intended to limit the disclosure to the specific embodiments illustrated by the figures or description below.

The present disclosure will not be described by referencing the appended figures representing preferred embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are with the spirit and scope of the present disclosure, are contemplated thereby, and are intended to be covered by the following general description.

The foregoing description comprises illustrative embodiments. Having thus described example embodiments, it should be noted by those skilled in the art that the within disclosures are example only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. Software for managing a non-profit comprising:
a top display layer with an intelligent dashboard configured for providing a first visual interactive display for an executive director of the non-profit, wherein the top display layer is configured for allowing a quick view of specific data points from management application tools; and
a bottom program layer of the management application tools, where the bottom program layer is configured to drive the executive director through the intelligent dashboard to connect the management application tools within the non-profit to drive greater efficiency and effectiveness of the non-profit.

2. The software for managing a non-profit of claim 1, wherein the software is configured to enable the executive director of the non-profit to understand critical moving pieces of the non-profit, where the intelligent dashboard integrates the important management application tools with custom workflows configured to guide the executive director into leveraging industry leading and proven best practices for managing the non-profit.

3. The software for managing a non-profit of claim 2, wherein the intelligent dashboard is configured to reduce requirements for the executive director to remember or manually navigate a plethora of systems required to run the non-profit on a daily basis, where the intelligent dashboard is configured to surface key data points, metrics, steps, and action items from the important management application tools with the custom workflows into the top display layer that is configured to automatically highlight or notify the executive director when something requires attention.

4. The software for managing a non-profit of claim 3, wherein the intelligent dashboard is configured to grow to include enriched training content with the custom workflows that guide the executive director on a specific area requiring attention, whereby the executive director is empowered to effectively deploy a vision and ultimately inspire and change lives in an increasingly simplified, organized and intentional way.

5. The software for managing a non-profit of claim 4, wherein the intelligent dashboard including:
an accounting gauge configured to highlight key financial items that aim to keep the non-profit on track from an accounting perspective, the accounting gauge includes accounting key performance indicators via integration with accounting software and via financial intermediary integration, where the accounting key performance indicators include:
current and last month balance;
real time profit/loss;
year to date;
budget vs. actual data; and
and latest transaction where a user can hover for last five latest transactions;
a development gauge configured to pull information from across multiple modules to highlight organizational level metrics, the development gauge including development key performance indicators from data within other modules including:
last or most recent gifts;
month to date donations;
lapsed donor list;
first time donors; and
a prompt if donation is greater than a set donation amount;
a donor pipeline module configured to provide a structured approach to working with a donor in a step-by-step manner to cultivate a strong relationship with the donor and to intentionally align interest of the donor with an organizational project, the donor pipeline module includes a donor key performance indicator gauge and a donor overview, where the donor key performance indicator gauge including:
new contact where the user can hover for the last five new contacts;
any red items;
total money proposed;
total money received;
most recent closed where the user can hover for the last five most recent closed;
a project module configured for ideas, projects, events, grants, programs categorizes and project worksheets, where the project module has a project key performance indicators gauge and a project overview, the project module including rolling icons;
a user management component configured for users and donors, where the user management component is configured to add and manage users, to add donors, and to sync with customer relationship management software;
an email widget component that integrates with email applications; and/or
a feedback component configured to provide the ability to provide feedback to a product team;
wherein, the intelligent dashboard is configured to leverage data insights from the accounting gauge, the development gauge, the donor pipeline module, the project module, the user management component, the email widget, and/or the feedback component for more use of the executive directors time as well as more efficiency to the organization.

6. The software for managing a non-profit of claim 5, wherein the intelligent dashboard further including a board engagement module or a human resources administration and management module.

7. The software for managing a non-profit of claim 5, wherein the intelligent dashboard is configured as an initial entry point for the executive director where it contains roll-up key performance indicators from the management application tools, a place to drag and drop files the executive director references on a regular basis, whereby the intelligent dashboard is configured to allow the executive director to manage the users, add the donors, and see relevant notifications.

8. The software for managing a non-profit of claim 6, wherein:
the donor pipeline module including at least four unique categories including individual, church, foundation, and organization, where each of the at least four unique categories is configured to have a unique set of steps and action items that a steward should complete while navigating the timeline of the pipeline,
the donor pipeline module including a list of donors where the user can click on each donor in the list to see a donor pipeline summary section where the user can click edit or continue to add detail including a contact tab, a proposal tab, a negotiation tab, a closure tab, and/or a steward tab;
the donor pipeline module including a new donor pipeline section configured to add new donors to the donor pipeline module;
the donor pipeline module including five vertical columns of phases, where each phase includes a plurality of steps to complete each phase, where the phases and steps are customizable, and a pipeline may be clicked and dragged from one phase to the next;
the donor pipeline module including a filtering dropdown list of stewards, where the donor pipeline module will filter out every pipeline item that the selected steward is not the steward of, where pipeline widgets of active pipelines, proposed money, received money, and goal are updated;
the donor pipeline module including a win and loss bucket section, where the user may drag a pipeline card into either a win bucket or a loss bucket configured to trigger a set of actions, wherein:
if won, a window appears asking for the amount received which will then filter into the pipeline widget for the received money;
or
combinations thereof.

9. The software for managing a non-profit of claim 6, wherein:
the project module is configured to provide a structured approach to delivering various types of projects in a step-by-step manner;
the project module is configured to emphasize proven steps and to send reminders to a project manager at key points in time;
the project module includes at least four unique types of projects including an ideas tab, a projects tab, an events tab, and a programs tab, where each type of project has a unique set of steps and action items configured to be completed by the project manager while navigating the timeline of the pipeline;
the project module includes an overview page configured to summarize all of the ongoing projects with the ability to filter by category;
the project module includes a project workflow that consists of project details, steps to be taken, and ongoing status updates, where the ongoing status updates are configured to be submitted from a mobile device, where when submitted the ongoing status updates are configured to be sent to the executive director, whereby the executive director can then forward the ongoing status updates to others;
the project key performance indicators of the project module include:
most recent created configured to show the last five most recent created when hovered over;
any item in projects that have turned red;
most recent closed configured to show the last five most recent closed when hovered over;
latest field report configured to show the last five latest field report when hovered over;
number of individuals impacted year to date;
budget spend year to date;
or
combinations thereof;
the project module includes a project summary page configured to provide a single place where all of the project details will be shown and be updated including an overall summary, and a projects updates page with each project update;
or
combinations thereof.

10. The software for managing a non-profit of claim 6 further including a reports module, wherein:
the reports module is configured to provide a streamlined process to transfer information and updates to stakeholders from the respective supported projects and programs;
the reports module is configured to allow the user to create reports which has customizable fields to be filled out by the field personnel;
the reports module is configured to provide the reports on recurring or predetermined frequencies;
the reports module is configured for field personnel to have access to the donor pipeline module under a special user type that will allow them to view, edit and submit their completed reports;
the reports module is configured to provide a notification to the user with the applicable permissions for review after the report has been submitted by the field personnel;
the reports module is configured to send out the report to all of the stakeholders that have been assigned to that report once the applicable user has reviewed and finalized the report;
the reports module is configured to add the reports in two ways: manual addition via a new reports page, and association with a donation target where a user can select a donation target as stakeholder for the report, whereby the user is making all givers in that donation target stakeholders for the report;
whereby, the reports module is configured wherein, when the report is created, stakeholders are defined, and when the report is completed, the report is reviewed and the report is sent to stakeholders;
or
combinations thereof.

11. The software for managing a non-profit of claim 6 wherein:
the user management component is configured to focus on two area, donor management and user management;
the user management component is configured to be a place where an authorized user can add or edit donors;
the user management component is configured to allow the authorized user to setup and sync with the customer relationship management software;
the user management component includes a list of donors page with links to view and edit each donor in an add/edit donor page with a submit new donor confirmation window;
the user management component is configured to enable administrators to add users and edit their permissions;
the user management component includes a list of users page with links to view and edit each user in an add/edit user page with a submit new user confirmation window;
or
combinations thereof.

12. The software for managing a non-profit of claim 6 wherein:
the email widget component is configured to give the executive director a view into the email applications without the need of going into the email applications;
the email widget component is configured to keep the executive director focused on broader aspects of the non-profit organization and not working only out of an inbox of the email applications;
the email widget includes email key performance indicators including a number of unread email count and the five most recent emails with from and subject;
the feedback component is configured to have a basic ability that will enable users to provide feedback to the team, where ideas can be marked with a smiley face or a frowning face configured to capture sentiment;
the feedback component is configured to include a brief message and a screenshot;
or
combinations thereof.

13. Software for managing a non-profit comprising:
a top display layer with an intelligent dashboard configured for providing a first visual interactive display for an executive director of the non-profit, wherein the top display layer is configured for allowing a quick view of specific data points from management application tools, where the management application tools; and
a bottom program layer of the management application tools, where the bottom program layer is configured to drive the executive director through the intelligent dashboard to connect the management application tools within the non-profit to drive greater efficiency and effectiveness of the non-profit;
wherein the intelligent dashboard including:
an accounting gauge configured to highlight key financial items that aim to keep the non-profit on track from an accounting perspective, the accounting gauge includes accounting key performance indicators via integration with accounting software and via financial intermediary integration, where the accounting key performance indicators include:
current and last month balance;
real time profit/loss;
year to date;
budget vs. actual data; and
and latest transaction where a user can hover for the last five latest transactions;
a development gauge configured to pull information from across multiple modules to highlight organizational level metrics, the development gauge including development key performance indicators from data within other modules including:
last or most recent gifts;
month to date donations;
lapsed donor list;
first time donors; and
a prompt if donation is greater than a set donation amount;
a donor pipeline module configured to provide a structured approach to working with a donor in a step-by-step manner to cultivate a strong relationship with the donor and to intentionally align interest of the donor with an organizational project, the donor pipeline module includes a donor key performance indicator gauge and a donor overview, where the donor key performance indicator gauge including:
new contact where the user can hover for the last five new contacts;
any red items;
total money proposed;
total money received;
most recent closed where the user can hover for the last five most recent closed;
the donor pipeline module including at least four unique categories including individual, church, foundation, and organization, where each of the at least four unique categories is configured to have a unique set of steps and action items that a steward should complete while navigating the timeline of the pipeline,
the donor pipeline module including a list of donors where the user can click on each donor in the list to see a donor pipeline summary section where the user can click edit or continue to add detail including a contact tab, a proposal tab, a negotiation tab, a closure tab, and/or a steward tab;
the donor pipeline module including a new donor pipeline section configured to add new donors to the donor pipeline module;
the donor pipeline module including five vertical columns of phases, where each phase includes a plurality of steps to complete each phase, where the phases and steps are customizable, and a pipeline may be clicked and dragged from one phase to the next;
the donor pipeline module including a filtering dropdown list of stewards, where the donor pipeline module will filter out every pipeline item that the selected steward is not the steward of, where pipeline widgets of active pipelines, proposed money, received money, and goal are updated; and
the donor pipeline module including a win and loss bucket section, where the user may drag a pipeline card into either a win bucket or a loss bucket configured to trigger a set of actions, wherein:
if won, a window appears asking for the amount received which will then filter into the pipeline widget for the received money;
a project module configured for ideas, projects, events, grants, programs categorizes and project worksheets, where the project module has a project key performance indicators gauge and a project overview, the project module including rolling icons;
the project module is configured to provide a structured approach to delivering various types of projects in a step-by-step manner;
the project module is configured to emphasize proven steps and to send reminders to a project manager at key points in time;
the project module includes at least four unique types of projects including an ideas tab, a projects tab, an events tab, and a programs tab, where each type of project has a unique set of steps and action items configured to be completed by the project manager while navigating the timeline of the pipeline;
the project module includes an overview page configured to summarize all of the ongoing projects with the ability to filter by category;
the project module includes a project workflow that consists of project details, steps to be taken, and ongoing status updates, where the ongoing status updates are configured to be submitted from a mobile device, where when submitted the ongoing status updates are configured to be sent to the executive director, whereby the executive director can then forward the ongoing status updates to others;
the project key performance indicators of the project module include:
most recent created configured to show the last five most recent created when hovered over;
any item in projects that have turned red;
most recent closed configured to show the last five most recent closed when hovered over;
latest field report configured to show the last five latest field report when hovered over;
number of individuals impacted year to date; and
budget spend year to date;
the project module includes a project summary page configured to provide a single place where all of the project details will be shown and be updated including the overall summary, and a projects updates page with each project update;
a user management component configured for users and donors, where the user management component is configured to add and manage users, to add donors, and to sync with customer relationship management software;
the user management component is configured to focus on two area, donor management and user management;
the user management component is configured to be a place where an authorized user can add or edit donors;
the user management component is configured to allow the authorized user to setup and sync with the customer relationship management software;
the user management component includes a list of donors page with links to view and edit each donor in an add/edit donor page with a submit new donor confirmation window;
the user management component is configured to enable administrators to add users and edit their permissions; and
the user management component includes a list of users page with links to view and edit each user in an add/edit user page with a submit new user confirmation window;
an email widget component that integrates with email applications;
the email widget component is configured to give the executive director a view into the email applications without the need of going into the email applications;
the email widget component is configured to keep the executive director focused on broader aspects of the non-profit organization and not working only out of an inbox of the email applications;
the email widget includes email key performance indicators including a number of unread email count and the five most recent emails with from and subject;
a feedback component configured to provide the ability to provide feedback to a product team;
the feedback component is configured to have a basic ability that will enable users to provide feedback to the team, where ideas can be marked with a smiley face or a frowning face configured to capture sentiment;
the feedback component is configured to include a brief message and a screenshot;
a board engagement module or a human resources administration and management module;
a reports module configured to provide a streamlined process to transfer information and updates to stakeholders from the respective supported projects and programs;
the reports module is configured to allow a user to create a report which has customizable fields to be filled out by the field personnel;
the reports module is configured to provide reports on recurring or predetermined frequencies;
the reports module is configured for field personnel to have access to the donor pipeline module under a special user type that will allow them to view, edit and submit their completed reports;
the reports module is configured to provide a notification to the user with the applicable permissions for review after the report has been submitted by the field personnel;
the reports module is configured to send out a report to all of the stakeholders that have been assigned to that report once the applicable user has reviewed and finalized the report;
the reports module is configured to add a report in two ways: manual addition via a new reports page, and association with a donation target where a user can select a donation target as stakeholder for a report, whereby the user is making all givers in that donation target stakeholders for the report;
whereby, the reports module is configured wherein, when a report is created, stakeholders are defined, and when a report is completed, the report is reviewed and the report is sent to stakeholders;
wherein, the intelligent dashboard is configured to leverage data insights from the accounting gauge, the development gauge, the donor pipeline module, the project module, the user management component, the email widget, and/or the feedback component for more use of the executive directors time as well as more efficiency to the organization;
wherein the intelligent dashboard is configured as an initial entry point for the executive director where it contains roll-up key performance indicators from the management application tools, a place to drag and drop files the executive director references on a regular basis, whereby the intelligent dashboard is configured to allow the executive director to manage users, add donors, and see relevant notifications;
wherein the software is configured to enable the executive director of the non-profit to understand critical moving pieces of the non-profit, where the intelligent dashboard integrates the important management application tools with custom workflows configured to guide the executive director into leveraging industry leading and proven best practices for managing the non-profit;
wherein the intelligent dashboard is configured to reduce requirements for the executive director to remember or manually navigate a plethora of systems required to run the non-profit on a daily basis, where the intelligent dashboard is configured to surface key data points, metrics, steps, and action items from the important management application tools with the custom workflows into the top display layer that is configured to automatically highlight or notify the executive director when something requires attention;
wherein the intelligent dashboard is configured to grow to include enriched training content with the custom workflows that guide the executive director on the specific area requiring attention, whereby the executive director is empowered to effectively deploy a vision and ultimately inspire and change lives in an increasingly simplified, organized and intentional way.

14. A method for managing a non-profit comprising:
providing software including:
a top display layer with an intelligent dashboard configured for providing a first visual interactive display for an executive director of the non-profit, wherein the top display layer is configured for allowing a quick view of specific data points from management application tools, where the management application tools including; and
a bottom program layer of the management application tools, where the bottom program layer is configured to drive the executive director through the intelligent dashboard to connect the management application tools within the non-profit to drive greater efficiency and effectiveness of the non-profit; and
the executive director utilizing the software to manage the non-profit.

15. The method for managing a non-profit of claim 14, wherein:
the software is configured to enable the executive director of the non-profit to understand critical moving pieces of the non-profit, where the intelligent dashboard integrates the important management application tools with custom workflows configured to guide the executive director into leveraging industry leading and proven best practices for managing the non-profit;
the intelligent dashboard is configured to reduce requirements for the executive director to remember or manually navigate a plethora of systems required to run the non-profit on a daily basis, where the intelligent dashboard is configured to surface key data points, metrics, steps, and action items from the important management application tools with the custom workflows into the top display layer that is configured to automatically highlight or notify the executive director when something requires attention;
wherein the intelligent dashboard is configured to grow to include enriched training content with the custom workflows that guide the executive director on a specific area requiring attention, whereby the executive director is empowered to effectively deploy a vision and ultimately inspire and change lives in an increasingly simplified, organized and intentional way;
or
combinations thereof.

16. The method for managing a non-profit of claim 14, wherein the intelligent dashboard including:
an accounting gauge configured to highlight key financial items that aim to keep the non-profit on track from an accounting perspective, the accounting gauge includes accounting key performance indicators via integration with accounting software and via financial intermediary integration, where the accounting key performance indicators include:
current and last month balance;
real time profit/loss;
year to date;
budget vs. actual data; and
and latest transaction where a user can hover for last five latest transactions;
a development gauge configured to pull information from across multiple modules to highlight organizational level metrics, the development gauge including development key performance indicators from data within other modules including:
last or most recent gifts;
month to date donations;
lapsed donor list;
first time donors; and
a prompt if donation is greater than a set donation amount;
a donor pipeline module configured to provide a structured approach to working with a donor in a step-by-step manner to cultivate a strong relationship with the donor and to intentionally align interest of the donor with an organizational project, the donor pipeline module includes a donor key performance indicator gauge and a donor overview, where the donor key performance indicator gauge including:
new contact where the user can hover for the last five new contacts;
any red items;
total money proposed;
total money received;
most recent closed where the user can hover for the last five most recent closed;
a project module configured for ideas, projects, events, grants, programs categorizes and project worksheets, where the project module has a project key performance indicators gauge and a project overview, the project module including rolling icons;
a user management component configured for users and donors, where the user management component is configured to add and manage users, to add donors, and to sync with customer relationship management software;
an email widget component that integrates with email applications;
a feedback component configured to provide the ability to provide feedback to a product team; and/or
a board engagement module or a human resources administration and management module;
wherein, the intelligent dashboard is configured to leverage data insights from the accounting gauge, the development gauge, the donor pipeline module, the project module, the user management component, the email widget, and/or the feedback component for more use of the executive directors time as well as more efficiency to the organization; and
wherein the intelligent dashboard is configured as an initial entry point for the executive director where it contains roll-up key performance indicators from the management application tools, a place to drag and drop files the executive director references on a regular basis, whereby the intelligent dashboard is configured to allow the executive director to manage users, add donors, and see relevant notifications.

17. The method for managing a non-profit of claim 16, wherein:
the donor pipeline module including at least four unique categories including individual, church, foundation, and organization, where each of the at least four unique categories is configured to have a unique set of steps and action items that the steward should complete while navigating the timeline of the pipeline,
the donor pipeline module including a list of donors where the user can click on each donor in the list to see a donor pipeline summary section where the user can click edit or continue to add detail including a contact tab, a proposal tab, a negotiation tab, a closure tab, and/or a steward tab;
the donor pipeline module including a new donor pipeline section configured to add new donors to the donor pipeline module;
the donor pipeline module including five vertical columns of phases, where each phase includes a plurality of steps to complete each phase, where the phases and steps are customizable, and a pipeline may be clicked and dragged from one phase to the next;
the donor pipeline module including a filtering dropdown list of stewards, where the donor pipeline module will filter out every pipeline item that the selected steward is not the steward of, where pipeline widgets of active pipelines, proposed money, received money, and goal are updated;
the donor pipeline module including a win and loss bucket section, where the user may drag a pipeline card into either a win bucket or a loss bucket configured to trigger a set of actions, wherein:
if won, a window appears asking for the amount received which will then filter into the pipeline widget for the received money;
or
combinations thereof.

18. The method for managing a non-profit of claim 16, wherein:
the project module is configured to provide a structured approach to delivering various types of projects in a step-by-step manner;
the project module is configured to emphasize proven steps and to send reminders to a project manager at key points in time;
the project module includes at least four unique types of projects including an ideas tab, a projects tab, an events tab, and a programs tab, where each type of project has a unique set of steps and action items configured to be completed by the project manager while navigating the timeline of the pipeline;
the project module includes an overview page configured to summarize all of the ongoing projects with the ability to filter by category;
the project module includes a project workflow that consists of project details, steps to be taken, and ongoing status updates, where the ongoing status updates are configured to be submitted from a mobile device, where when submitted the ongoing status updates are configured to be sent to the executive director, whereby the executive director can then forward the ongoing status updates to others;
the project key performance indicators of the project module include:
most recent created configured to show the last five most recent created when hovered over;
any item in projects that have turned red;
most recent closed configured to show the last five most recent closed when hovered over;
latest field report configured to show the last five latest field report when hovered over;
number of individuals impacted year to date;
budget spend year to date;
or
combinations thereof;
the project module includes a project summary page configured to provide a single place where all of the project details will be shown and be updated including the overall summary, and a projects updates page with each project update;
or
combinations thereof.

19. The method for managing a non-profit of claim 16 further including a reports module, wherein:
the reports module is configured to provide a streamlined process to transfer information and updates to stakeholders from the respective supported projects and programs;
the reports module is configured to allow a user to create a report which has customizable fields to be filled out by the field personnel;
the reports module is configured to provide reports on recurring or predetermined frequencies;
the reports module is configured for field personnel to have access to the donor pipeline module under a special user type that will allow them to view, edit and submit their completed reports;
the reports module is configured to provide a notification to the user with the applicable permissions for review after the report has been submitted by the field personnel;
the reports module is configured to send out a report to all of the stakeholders that have been assigned to that report once the applicable user has reviewed and finalized the report;
the reports module is configured to add a report in two ways: manual addition via a new reports page, and association with a donation target where a user can select a donation target as stakeholder for a report, whereby the user is making all givers in that donation target stakeholders for the report;
whereby, the reports module is configured wherein, when a report is created, stakeholders are defined, and when a report is completed, the report is reviewed and the report is sent to stakeholders;
or
combinations thereof.

20. The method for managing a non-profit of claim 16 wherein:
the user management component is configured to focus on two area, donor management and user management;
the user management component is configured to be a place where an authorized user can add or edit donors;
the user management component is configured to allow the authorized user to setup and sync with the customer relationship management software;
the user management component includes a list of donors page with links to view and edit each donor in an add/edit donor page with a submit new donor confirmation window;
the user management component is configured to enable administrators to add users and edit their permissions;
the user management component includes a list of users page with links to view and edit each user in an add/edit user page with a submit new user confirmation window;
the email widget component is configured to give the executive director a view into the email applications without the need of going into the email applications;
the email widget component is configured to keep the executive director focused on broader aspects of the non-profit organization and not working only out of an inbox of the email applications;
the email widget includes email key performance indicators including a number of unread email count and the five most recent emails with from and subject;
the feedback component is configured to have a basic ability that will enable users to provide feedback to the team, where ideas can be marked with a smiley face or a frowning face configured to capture sentiment;
the feedback component is configured to include a brief message and a screenshot;
or
combinations thereof.
